(19) United States
(12) Patent Application Publication
(10) Pub. No.: US 2019/0029201 A1
(43) Pub. Date: Jan. 31, 2019

(54) HIGH DENSITY INDOOR FARMING APPARATUS, SYSTEM AND METHOD

(71) Applicant: Revolution Farm Technologies, LLC, Elkins Park, PA (US)

(72) Inventor: Jack GRIFFIN, Philadelphia, PA (US)

(73) Assignee: Revolution Farm Technologies, LLC, Elkins Park, PA (US)

(21) Appl. No.: 16/150,571

(22) Filed: Oct. 3, 2018

Related U.S. Application Data
(63) Continuation-in-part of application No. 16/110,399, filed on Aug. 23, 2018.
Application No. 16/110,399 is a continuation-in-part of application No. 15/472,106, filed on Mar. 28, 2017.
(60) Provisional application No. 62/549,053, filed on Aug. 23, 2017.
(60) Provisional application No. 62/345,621, filed on Jun. 3, 2016.
(60) Provisional application No. 62/567,408, filed on Oct. 3, 2017.
(60) Provisional application No. 62/572,217, filed on Oct. 13, 2017.

(51) Int. Cl. A01G 31/06; A01G 7/04; A01G 27/00

(52) U.S. Cl. CPC A01G 31/06; A01G 2031/006; A01G 27/008; A01G 7/045

(57) ABSTRACT

An indoor farming system includes a water-based nutrient bath resident in a tank and a pump for pumping the bath from the tank upwardly through a plurality of pipes to at least one divided high-density table comprising growing crops resting in at least one float. The plurality pipes includes at least one valve suitable to shut off the bath per each of the high density tables. At least one non-block drain is coupled to the at least one divided high-density table. The bath turbulently flows respectively across the at least one divided high-density table, down the at least one non-block drain, and back into the tank that includes the nutrient bath. A lighting system provides moving light from points above the growing crops.

### CROSS-REFERENCE TO RELATED APPLICATIONS

This application is a continuation-in-part of U.S. patent application Ser. No. 16/110,399, filed on Aug. 23, 2018, entitled “HIGH DENSITY INDOOR FARMING APPARATUS, SYSTEM AND METHOD,” which claimed priority to U.S. Provisional Application Ser. No. 62/549,053, filed on Aug. 23, 2017, entitled “HIGH DENSITY INDOOR FARMING APPARATUS, SYSTEM AND METHOD,” a continuation-in-part of U.S. patent application Ser. No. 15/472,106, filed on Mar. 28, 2017, entitled “HIGH DENSITY INDOOR FARMING APPARATUS, SYSTEM, AND METHOD,” which claimed priority to U.S. Provisional Application No. 62/345,621, filed on Jun. 3, 2016, and further claims benefit of U.S. Provisional Application Ser. No. 62/567,408, filed on Oct. 3, 2017, entitled “HIGH DENSITY INDOOR FARMING APPARATUS, SYSTEM AND METHOD,” and U.S. Provisional Application Ser. No. 62/572,217, filed Oct. 13, 2017 entitled “HIGH DENSITY INDOOR FARMING APPARATUS, SYSTEM AND METHOD,” each of which is incorporated herein by reference in its entirety.

### FIELD

The present disclosure is directed generally to methods and systems of indoor farming, and more particularly is directed to high density indoor farming apparatuses, systems and methods.

### BACKGROUND

Hydroponic farming includes the practice of producing food and other plants (e.g., medicinal) without soil, using mineral nutrient solutions. One form of hydroponic farming, vertical farming, includes vertically stacked, vertically inclined surfaces configured for hydroponic farming Current hydroponic and/or vertical farming systems suffers from a variety of issues. For example, current hydroponic and/or vertical farming systems lack sufficient density for farming, requiring higher vertical stacks and/or a greater number of stacks than is currently feasible. Current systems further have insufficient or improper lighting, need to be cleaned on a frequent basis, and have a lack of crop health, among other issues.

### SUMMARY

In various embodiments, an indoor farming system is disclosed. The indoor farming system includes a water-based nutrient bath resident in a tank and a pump for pumping the bath from the tank upwardly through a plurality of pipes to at least one divided high-density table comprising growing crops resting in at least one float. The plurality pipes includes at least one valve suitable to shut off the bath per each of the high density tables. At least one non-block drain is coupled to the at least one divided high-density table. The bath turbulently flows respectively across the at least one divided high-density table, down the at least one non-block drain, and back into the tank that includes the nutrient bath. A lighting system provides moving light from points above the growing crops.

### BRIEF DESCRIPTION OF THE FIGURES

The present disclosure is illustrated by way of example and not limitation in the figures of the accompanying drawings, in which like references indicate similar elements and in which:

FIG. 1 illustrates a front perspective view of a vertical farming system, in accordance with some embodiments;

FIG. 2 illustrates a side perspective view of the vertical farming system of FIG. 1, in accordance with some embodiment;

FIG. 3A illustrates a front view of flow table of the vertical farming system of FIG. 1, in accordance with some embodiments;

FIG. 3B illustrates a side perspective view of the flow table of FIG. 3A, in accordance with some embodiments;

FIG. 4A illustrates a first float board sized and configured to be received within an opening defined by the flow table of FIG. 3A, in accordance with some embodiments;

FIG. 4B illustrates the first float board of FIG. 4A having a growth medium disposed within at least one hole defined in the first float board, in accordance with some embodiments;

FIG. 5 illustrates a second float board sized and configured to be received within an opening defined by the flow table of FIG. 3A, in accordance with some embodiments;

FIG. 6 illustrates a light enclosure of the vertical farming system of FIG. 1, in accordance with some embodiments;

FIG. 7 illustrates a lighting system including the light enclosure of FIG. 6, in accordance with some embodiments;

FIG. 8 illustrates a lighting system configured to adjust a position of a light source in a first axis parallel to a plane of a flow table and a second axis perpendicular to the plane of the flow table;

FIG. 9 illustrates a system diagram of a modular vertical farming system, in accordance with some embodiments;

FIG. 10 illustrates a Venturi pressurized system of the modular vertical farming system of FIG. 9, in accordance with some embodiments;

FIG. 11 illustrates a modular portion of the Venturi pressurized system of FIG. 10, in accordance with some embodiments;

FIG. 12A illustrates a first spray bar configured for use in the vertical farming system of FIG. 9 including a slit extending lengthwise on at least one tangent point on the first spray bar, in accordance with some embodiments;

FIG. 12B illustrates a cross-sectional view of the first spray bar of FIG. 12A, in accordance with some embodiments

FIG. 12C illustrates a second spray bar configured for use in the vertical farming system of FIG. 9 including a plurality of openings formed along a first side of the second spray bar, in accordance with some embodiments;

FIG. 13 illustrates a tank cover for covering a water tank of the vertical farming system of FIG. 1 or 9, in accordance with some embodiments;

FIG. 14A illustrates a rotatable water inlet configured to provide modular attachment between a flow table and a water tank of the vertical farming systems of FIG. 1 or 9, in accordance with some embodiments;

FIG. 14B illustrates a rotatable drain coupled to a flow table configured for modular attachment within the vertical farming system of FIG. 9, in accordance with some embodiments;

FIG. 15 illustrates a float board having a plurality of openings sized and configured to receive mature plants therein, in accordance with some embodiments; and

FIG. 16 illustrates a vertical farming growth facility including a plurality of vertical farming systems, in accordance with some embodiments.

FIG. 17 illustrates a water tank having a chilling system formed integrally therewith, in accordance with some embodiments.

FIG. 18 illustrates a flow system including a plurality of decoupling tanks and a chilling system, in accordance with some embodiments.

FIG. 19 illustrates a ballast circuit for use in a lighting system of the vertical farming system, in accordance with some embodiments.

FIGS. 20(1)-20(4) (collectively FIG. 20) illustrate a circuit diagram of a ballast circuit for use in a lighting system of the vertical farming system, in accordance with some embodiments.

### DETAILED DESCRIPTION

It is to be understood that the figures and descriptions of the present disclosure have been simplified to illustrate elements that are relevant for a clear understanding of the discussed embodiments, while eliminating, for the purpose of clarity, many other elements found in known apparatuses, systems, and methods. Those of ordinary skill in the art may thus recognize that other elements and/or steps are desirable and/or required in implementing the disclosure. However, because such elements and steps are known in the art, and because they consequently do not facilitate a better understanding of the disclosure, for the sake of brevity a discussion of such elements and steps is not provided herein. Nevertheless, the disclosure herein is directed to all such elements and steps, including all variations and modifications to the disclosed elements and methods, known to those skilled in the art.

Exemplary embodiments are provided so that this disclosure will be thorough, and will fully convey the scope to those who are skilled in the art. Numerous specific details are set forth, such as examples of specific components, devices, and methods, to enable a thorough understanding of embodiments of the present disclosure. It will be apparent to those skilled in the art that specific details need not be employed, that is, that the exemplary embodiments may be embodied in many different forms and thus should not be construed to limit the scope of the disclosure. For example, in some exemplary embodiments, well-known processes, well-known device structures, and well-known technologies are not described in detail.

The terminology used herein is for the purpose of describing particular example embodiments only and is thus not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

As to the methods discussed herein, the method steps, processes, and operations described herein are not to be construed as necessarily requiring their performance in the particular order discussed or illustrated, unless specifically identified as having an order of performance. It is also to be understood that additional or alternative steps may be employed.

When an element or layer is referred to as being “on”, “atop”, “engaged to”, “connected to,” “coupled to,” or a like term or phrase with respect to another element or layer, it may be directly on, engaged, connected or coupled to the other element or layer, or intervening elements or layers may be present. In contrast, when an element is referred to as being “directly on,” “directly engaged to”, “directly connected to”, “directly atop”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The various exemplary embodiments will be described herein below with reference to the accompanying drawings. In the following description and the drawings, well-known functions or constructions are not shown or described in detail since they may obscure the disclosed embodiments with the unnecessary detail.

In various embodiments, an apparatus, system, and method for high density vertical farming are disclosed.

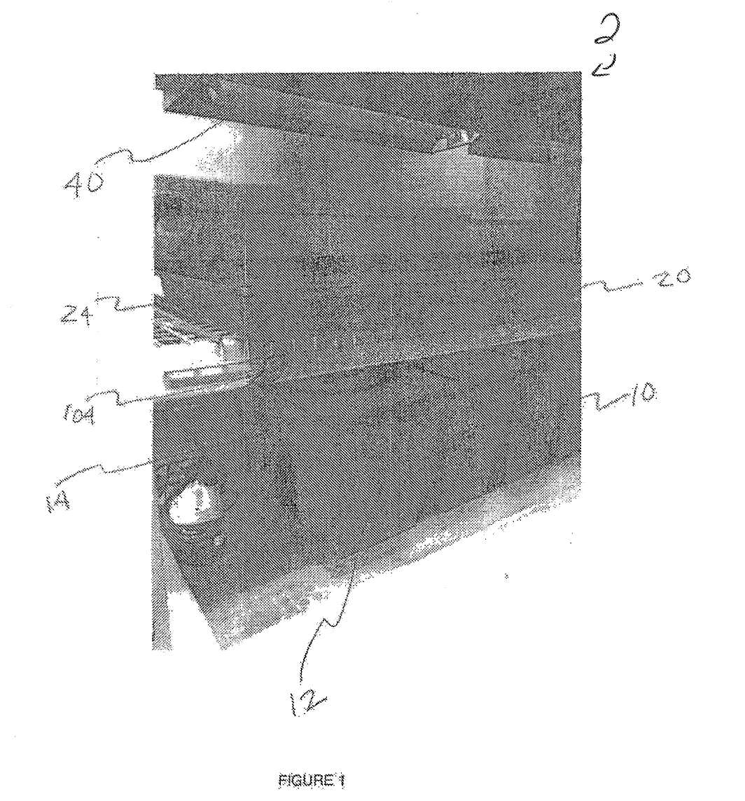

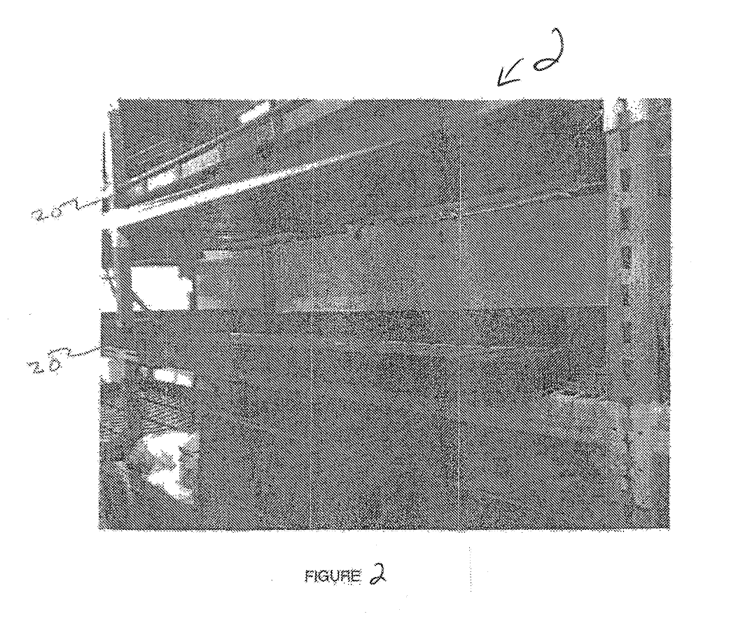

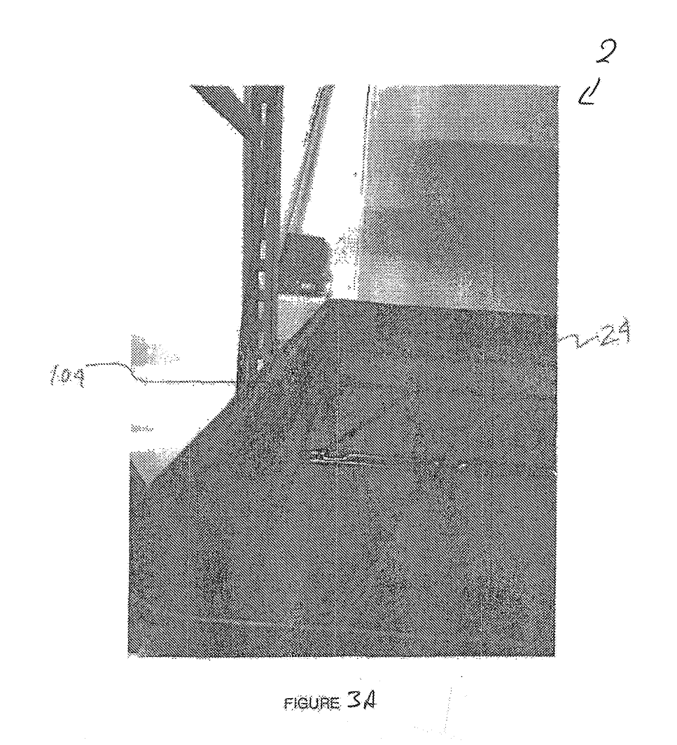

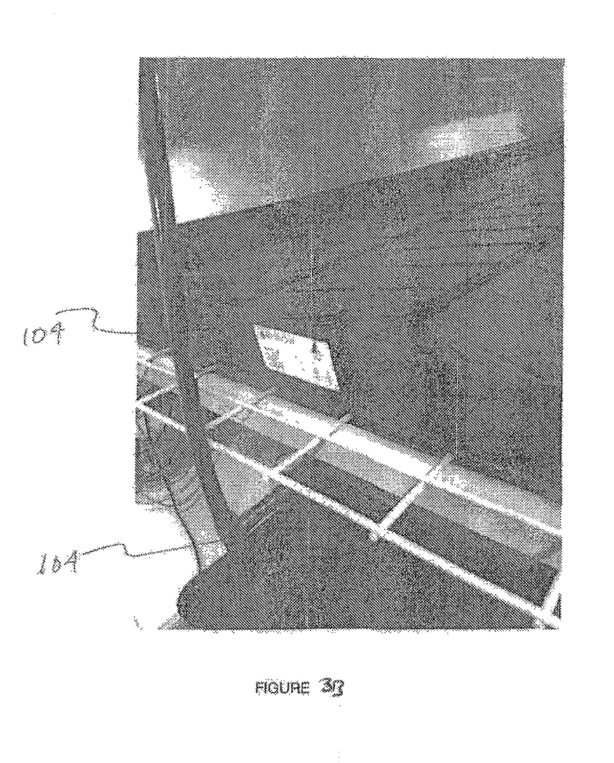

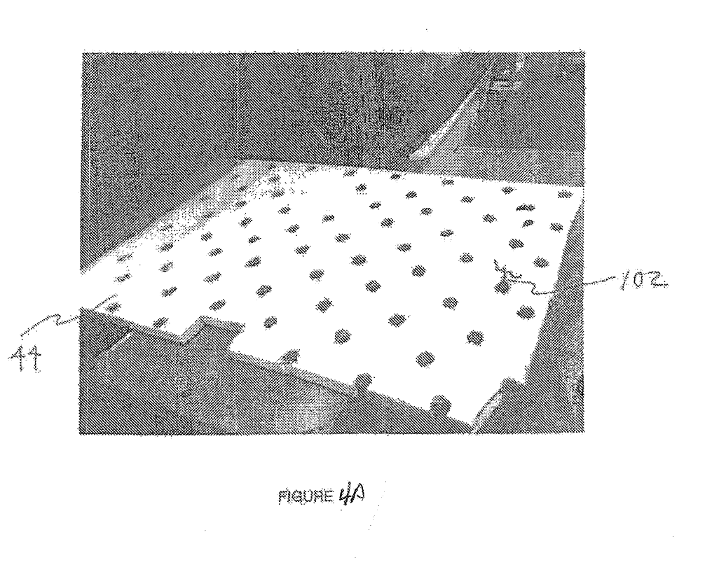

FIGS. 1-3 illustrate a vertical farming system 2 including a plurality of flow tables 20, in accordance with some embodiments. The flow tables 20 are arranged in a stacked configuration with one or more flow tables 20 being positioned above and/or below each of the other flow tables 20 in the vertical farming system 2. The flow tables 20 can include an ebb and flow water system, as discussed in greater detail below. The vertical farming system 2 includes a water-based nutrient solution 10 resident in a tank 12. The tank 12 can include any suitable volume, such as for example, at least 250 gallons, at least 500 gallons, etc. In some embodiments, the tank 12 includes an environmentally sealed tank. A pump 14 is positioned within the tank 12 and is configured to pumping the water-based nutrient solution from the tank 12 to each of the vertically stacked flow tables 20. Although embodiments are discussed herein including a tank 12 containing a water-based nutrient solution 10, it will be appreciated that the system can include multiple tanks, such as, for example, a first tank containing a nutrient solution (and/or nutrient source) and a second tank containing water, which may be separately and/or jointly provided to the flow tables 20.

In various embodiments, the vertical farming system can include between two and eight levels of vertically stacked flow tables 20. Each of the flow tables can include any suitable dimensions. For example, in some embodiments, each of the vertically stacked flow tables 20 includes a length in a range of about 6 feet to about 10 feet, for example, 6 feet, 8 feet, 10 feet, etc. Each of the vertically stacked flow tables 20 may have similar and/or different dimensions with respect to one or more other vertically stacked flow tables 20 in the vertical farming system 2.

In some embodiments, each of the high-density tables 20 includes an water in-flow system and a water out-flow system. The water in-flow system can include an inlet XA configured to provide in-flow of the water-based nutrient solution 10 from the water tank 12 to a first side of each of the flow tables 20. The water out-flow system can include one or more drains 24 configured to provide out-flow of the water-based nutrient solution 10 from a second side of each of the flow tables 20 to the water tank 12. The one or more drains 24 can include any suitable drain, such as an anti-block drain.

In some embodiments, each of the flow tables 20 is angled and/or inclined from a higher, first side to a lower, second side to allow flow of the water-based nutrient solution 10 from the first side to the second side, for example, due to the force of gravity. For example, in some embodiments, the water in-flow system is configured to provide flow of the water-based nutrient solution 10 to the first side of each of the flow tables 20. The water-based nutrient solution 10 flows down from the higher first side to the second side and is removed from the respective flow table 20 by one or more drains 24 formed integrally with the flow table 20.

In some embodiments, the water-based nutrient solution 10 may be turbulently provided (e.g., “bubbled”) through the inlet XA to a first side 22a of the flow table 20. The water-based nutrient solution 10 is dispersed by the turbulence and flows across the flow table 20 to the second side 22b of the flow table 20 and out-flows through the one or more drains 24. The water-based nutrient solution 10 is provided from the one or more drains 24 back to the tank 12. The water-based nutrient solution 10 is provided at a first temperature from the tank 12. In some embodiments, the temperature of the water-based nutrient solution 10 is maintained at a substantially constant temperature within the flow table 20, for example, by insulation provided by a float board positioned within the flow table 20, as described in greater detail below. In some embodiments, one or more temperature controls are formed integrally with and/or coupled to the tank 12 to maintain the water-based nutrient solution 10 at the predetermined temperature. In some embodiments, the in-flow system and/or the out-flow system includes flushing and filtering systems for the water-based nutrient solution 10.

In some embodiments, the vertical farming system 2 includes a plurality of floats 44 configured to be positioned within each of the flow tables 20. Each of the plurality of floats 44 includes a material configured to float atop the water-based nutrient solution 10 within the float table 20. For example, in some embodiments, each of the floats 44 includes a foam material, although it will be appreciated that any suitable material can be used. In some embodiments, the material of the float 44 is configured to absorb a portion of the water-based nutrient solution 10 and/or to provide insulation to the portion of the water-based nutrient solution 10 positioned beneath the float 44. In some embodiments, each float 44 may be readily modifiable, such as being easily cut, to provide any desired density for particular plants to be grown within the float 44. For example, in various embodiments, each float 44 may include a foam material of a suitable thickness to suspend a growing plant at the desired height above the water-based nutrient solution (e.g., to cause a “stretch” between the roots of the plant and the water-based nutrient solution 10) and/or to sufficiently insulate the plants roots and the water-based nutrient solution 10 from heat generated by overhead lighting, such as the lighting system described in greater detail below. For example, in some embodiments, each of the floats 44 may have a thickness of about 1 to about 4 inches, such as, 1 inch, 2 inches, 2.5 inches, 3 inches, 3.5 inches, 4 inches, etc. Although specific embodiments are discussed herein, it will be appreciated that each of the floats 44 can include any suitable material and be of any suitable dimensions and/or thickness to support a predetermined number of plants at a predetermined height with respect to the flow table 20 and/or the water-based nutrient solution 10 within the flow table 20.

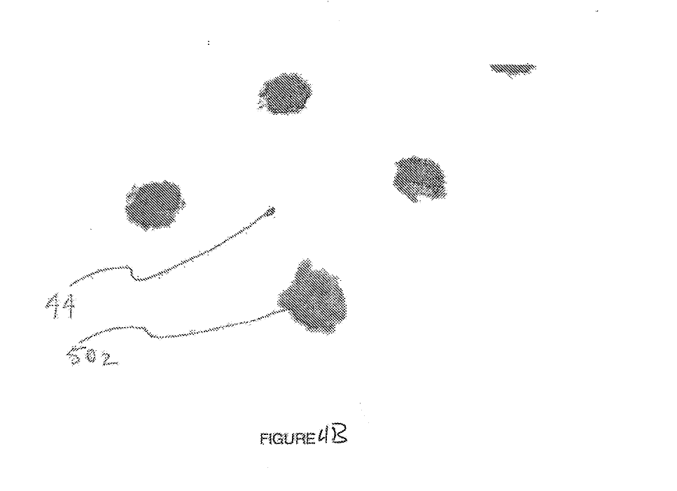

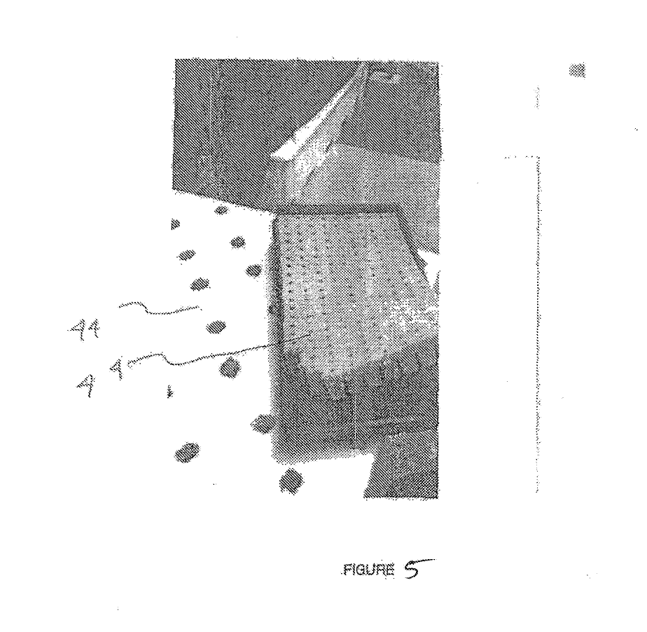

FIG. 4A illustrates a first float 44a, in accordance with some embodiments. The first float 44 includes a rectangular-section of foam (or foam-like) material having a plurality of openings 46 formed therethrough. Each of the plurality of openings 46 is configured to receive a plant and/or a plant retaining element therein. For example, as illustrated in FIG. 4B, in some embodiments, each of the openings 46 is sized and configured to receive a growth medium XB containing at least one plant therein. The growth medium 502 can include any suitable growth medium, such as, for example, volcanic rock wool (also referred to as “rock wool”). In some embodiments, the growth medium is partially inserted through each opening such that a portion of the growth medium extends above and/or below the first float 44a. For example, in some embodiments, a plant seedling may be initially grown in a growth medium 502, such as rock wool, to improve germination of each plant. When each plant reaches a desired height, it may be readily replanted within the float 44a. The openings 46 within the float 44a are configured to receive the growth medium 502 therein and retains the growth medium 502 (and therefore the germinated plant) at a predetermined height with respect to the water-based nutrient solution 10 within a respective flow table 20.

In some embodiments, the first float 44a has a density such that the first float 44a is configured to float on the water-based nutrient solution 10 passing through the respective flow table 20 containing the first float 44a. The first float 44a is able to move in a vertical direction (i.e., up and down) within the flow table 20 as the fluid level of the water-based nutrient solution 10 increases and/or decreases. Movement of the first float 44a maintains the growth medium and/or a plant contained within the growth medium at a predeteimined depth within the water-based nutrient solution 10 regardless of the depth of the water-based nutrient solution 10 within the flow table 20.

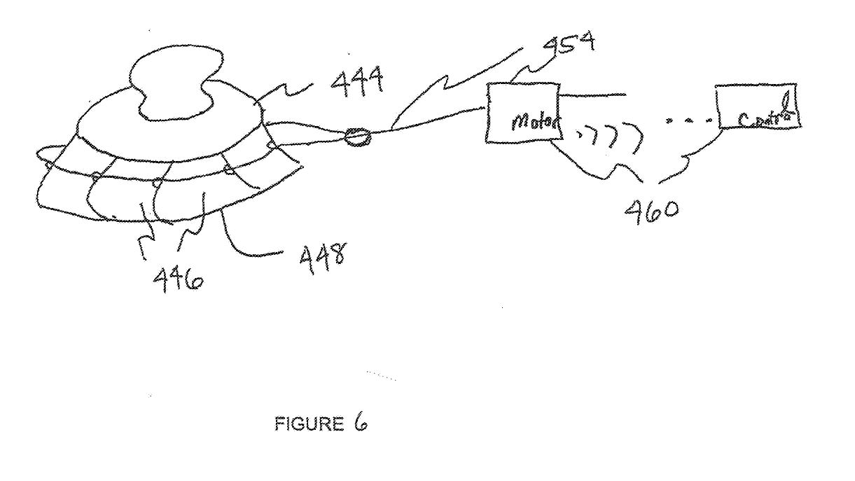

FIG. 5 illustrates a second float 44b, in accordance with some embodiments. The second float 44b is similar to the first float 44a described in conjunction with FIG. 4A, and similar description is not repeated herein. The second float 44b includes a plurality of elongated channels 45 (or containers) configured to receive a growth medium and/or a plant therein. For example, in the illustrated embodiment, the second float 44b defines a plurality of elongated channels 45 each defining a first opening 46 at a first side and a second opening (now shown) at a second side. Each of the plurality of elongated channels 45 is defined by a sidewall 47 extending along an axis perpendicular to a plane defined by the second float 44b. The sidewalls 47 each include a pyramid and/or prism shape such that the elongated channels 45 taper from a widest point adjacent the first opening 46 to a thinnest (or smallest) point adjacent the second opening. Each of the plurality of elongated channels 45 are configured to receive a growth medium and/or a plant therein and maintain the growth medium and/or the plant in a fixed position based on a friction fit between the sidewall 47 and the growth medium/plant. Although specific embodiments are disclosed herein, it will be appreciated that a float board can have any suitable shape sized and configured to maintain growth medium and/or plants at a fixed lateral position within a flow table 20.

In some embodiments, the vertical farming system 2 includes a plurality of lighting systems 40 configured to provide light above, and in close proximity to, each of the flow tables 20. The lighting system 40 may include any suitable type of light-emitting element, such as, for example, induction lighting, light-emitting diodes (LED), organic light-emitting diodes (OLED), and/or any other suitable light emitting elements. In some embodiments, the lighting system 40 is adjustable such that the lighting system 40 and/or one or more elements of the lighting system 40 (such as a light emitting element) may be moved within a plane parallel to a plane of the flow table 20 and/or vertically with respect to the plane of the flow table 20.

In some embodiments, the vertical farming system 2 includes at least one lighting system 40 positioned above each of the flow tables 20 within the vertical stack. For example, some embodiments, each flow table 20 has a single lighting system 40 positioned directly above the flow table 20. In other embodiments, a single lighting system 40 may provide light to multiple flow tables 20 arranged horizontally on a single level of the vertical farming system 2 and/or multiple lighting systems 40 may be arranged horizontally above a single flow table 20.

In some embodiments, the lighting system 40 includes heat-producing induction light elements. Although induction elements have been traditionally avoided in hydroponic farming, the vertical farming system 2 provides several advantages that allow for the use of induction light elements. For example, in some embodiments, each of the floats 44 is configured to insulate a root system of a plant and/or the water-based nutrient solution 10 within a flow table 20 from the heat generated by the induction light elements. The float 44 may be configured such that the root system and/or the water-based nutrient solution 10 are maintained at a predetermined temperature. For example, it is known in the hydroponics field that, for some plants, every 5-10 degrees above 70 degrees Fahrenheit that water/plant roots are heated, oxygenation to the plant may be cut by up to half (resulting in induction lighting being typically disfavored in the art). The use of the heat absorbing float 44 prevents heat transfer to the root system and/or water-based nutrient solution 10, enabling the use of induction lighting without increasing the temperature of the root system and/or water-based nutrient solution 10. The use of heat absorbing floats 44 minimizes the need to make significant adjustments in the proximity of the lights and the temperature of the water for various different crops. In some embodiments, the induction light elements are configured to generate broad spectrum lighting.

In some embodiments, each of the lighting systems 40 is configured to be adjustable in a plane parallel to a plane defined by the float table 20 and/or perpendicular to the plane defined by the float table 20. For example, in some embodiments, each of the lighting systems 40 (or a portion of each lighting system, such as a light emitting element) can be vertically adjusted with respect to the flow table 20. The vertical position of the lighting system may be adjusted using any suitable mechanism, such as, for example, a pulley or pulley system, a catch and/or manual adjustment shelving system, an electric drive system, a hydraulic system, a pneumatic system, and/or any other suitable adjustment mechanism.

In some embodiments, the vertical farming system 2 is configured to be adapted to accommodate growth of any selected crop 102. For example, in various embodiments, the vertical farming system 2 can be adapted by adjustments to one or more of the water-based nutrient solution 10, the in-flow system, the out-flow system, the lighting system 40, the flow tables 20, the floats 44, and/or any other suitable portion of the vertical farming system 2. For example, in various embodiments, one or more floats 44 may be selected to provide a predetermine density for supporting a selected type of plant and/or for insulating the root system of the plant. In other embodiments, the number of tables 20 and/or lighting systems 40 can be increased and/or decreased depending on the space and lighting needs of the selected plant.

In some embodiments, one or more of the float tables 20 includes a cut-off point detector configured to prevent flooding. The cut-off point detector may include a switch or other mechanism configured to cut-off flow of the water-based nutrient solution 10 from the tank 12 if a float 44 within the float table 20 rises above a predetermined level. The cut-off point detector may include any suitable mechanism, such as, for example, a simple mechanical switch, a flooding prevention switch, etc., although it will be appreciated that any suitable cut-off mechanism and/or detector can be used. In some embodiments, the use of a mechanical switch reduces complexity of the vertical farming system 2 as compared to systems using a flooding prevention switch.

In some embodiments, the vertical farming system 2 provides a scalable multi-level hydroponic farming system. As discussed above, the vertical farming system 2 enables the use of broad spectrum lighting, such as induction lighting, without overheating plants. Further, and as discussed above, floats 44 may be employed of any desired depth and density to optimize yield on a crop by crop basis. The height of each flow table 20 and/or the distance of the flow table 20 from the lighting system 40, may preferably be adjustable. The number of platforms, the depth of the float, and the distance from the lighting system for each crop may be entirely adjustable based on the crop being grown.

The vertical farming system 2 enables crops to be grown in almost any indoor farm setting, including, for example, in a “flash farm” or “artisan farm” context. Multi-level farming may be performed in any suitable sized space, such as spaces ranging the size of a single float table and shelving at a single level (for example, about 7 sq. ft.) up to warehouse or industrial scales (for example, 10,000 sq. ft. or more). The vertical farming system 2 allows any person and/or business to engage in indoor farming. For example, restaurants may implement a vertical farming system 2 to engage in their own farming of crops used. As another example, the vertical farming system 2 allows farming to be readily available even in urban areas where space is at a premium. In one embodiment, sixty flow tables 20 may be provided, with each float table 20 being about 8 ft. by 4 ft., requiring as little as 1,600 sq. ft. of space. Although specific embodiments are discussed herein, it will be appreciated that the vertical farming system 2 can be adjusted to fit within any suitable space capable of containing components of the vertical farming system 2 discussed herein.

In some embodiments, the vertical farming system 2 enables the non-use (or elimination) of pesticides and/or animal waste (e.g., animal-based fertilizer), providing heightened cleanliness of the food growing environment (e.g., the facility containing the vertical farming system 2). In some embodiments, various restrictions typically employed in electronics clean rooms may be employed in to maintain the cleanliness of a facility containing a vertical farming system 2. Various methods may be employed to keep out bugs, bacteria, mold, pests, and/or other environmental factors. For example, facilities containing a vertical farming system 2 may have intake restrictions (e.g., no outside food or drink, no outside products, use of sterilized suits, etc.). In some embodiments, cleanliness may be optimized, airlocks may be provided at entry and exit, kosher food protocols may be followed, and/or other controls may be enacted to maintain the environment within a facility. Although specific environments are discussed herein, it will be appreciated that the vertical farming system 2 can be placed in any environment while still providing improved cleanliness and maximum crop yield.

Additionally, as a further advantage, the vertical farming system 2 uses 98% less water than standard (or traditional) farming systems. The vertical farming system 2 enables recycling of the water-based nutrient solution. For example, the use of large, sealed tanks eliminates sources of water loss and/or contamination. Water-based nutrient solution 10 is lost only to plant absorption and minor evaporation. Minimizing evaporation through the relative sealing of the tanks, in conjunction with the increased size of the tanks, minimizes the need to add nutrients or water to the system as compared to previous systems.

In some embodiments, the minimization of water loss and the non-use of animal waste reduces the need to flush the water tank 12. For example, in some embodiments, the water tank 12 and/or the in-flow and out-flow systems for one or more float tables may only need to be flushed and/or cleaned every four to five months, although it will be appreciated that the frequency of cleaning may be dictated by the components of the water-based nutrient solution 10, the types of plants being grown, the environment around the vertical farming system 2, and/or other parameters. Additionally, the reuse of the water-based nutrient solution 10 for extended periods of time prevents contamination of local water systems.

As an additional advantage, the number of human “touch points” in the vertical farming system 2 is appreciably below previous systems. In prior hydroponic and/or non-hydroponic farming systems, the number of human hands that touch food during growth and processing is immense, which can lead to contamination of diseases and/or pathogens, such as E. Coli, listeria, and/or other food borne diseases. In the vertical farming system 2, each plant is touched only twice, first when implanted in the rock wool and again when removed from the rock wool (i.e., harvested). Cleaning of the plants is unnecessary, due to the heightened clean state of growth and the lack of pesticides and animal-based products. Further, movement or adjustment of the plants is unnecessary due to the adjustable lighting system and/or the use of floats 44, as discussed above.

In some embodiments, the clean state of the water-based nutrient solution 10 allows for “plant improvement” stations. For example, in the event a water-based nutrient solution 10 is not producing plants with optimized growth or flavor, the respective plants may be moved to a cleaning station where a different water-based nutrient solution (having different levels and/or types of components) is provided to clear out plant salts and improve taste. Movement to the plant improvement station does not require human interaction with each individual plant but instead is accomplished by moving the float 44, limiting human interaction to only the float 44. Further, interaction with the float 44 can be limited through the use of tools, gloves, etc. to further limit potential contamination. In some embodiments, movement of floats 44 (and the respective plants therein) from one station to another optimizes plant growth, for example, through shelf movement, light changes, float movement, nutrient solution changes, the use of cleanliness stations, lack of need to flush the system, and end stage filtering for nutrient solution flushes.

In some embodiments, the vertical farming system 2 provides exceedingly high density of plant growth. For example, the clean nature of the growth process in conjunction with the use of large, sealed water tanks in the watering system, enables higher density as compared to previous systems. The vertical farming system 2 provides an increase in density of plants over traditional farming methods. For example, in some embodiments, a density increase of over 200 times a traditional farm density (or yield) can be achieved using the vertical farming system 2 (i.e., the yield of a traditional 15-acre farm can be equaled using a warehouse of less than 5,000 sq. ft.). High density growth allows for growth in urban areas, allowing locally grown plants. For example, in the event of a disaster, the vertical farming system 2 enables the availability of food at a point of necessity without needing to bring food from the outside.

In some embodiments, the vertical farming system 2 increases the quality and health of plants grown. For example, because each plant has a balanced water-based nutrient solution 10 that provides predetermined and optimal nutrients, pH levels and the like specific to each plant at an optimal temperature and has an optimal access to air, each plant can grow in an optimal manner. Such optimal plant growth produces optimal taste and quality in grown plants. Moreover, because the suspension of the plants by the float allows the roots of each plant to “reach out” to the water, a low amount of water is needed to optimize the plant growth rate. The plant growth rate may be further optimized based on the use of broad spectrum lighting, as discussed above.

The optimization of plant growth throughout provides several benefits. For example, optimized growth provides maximum yield in minimal time, as well as providing crops that grow at such a high rate of speed that the crops reach maturity that before bacteria and/or parasites have an opportunity to take hold. The vertical farming system 2 enables control of one or more factors for optimizing plant growth. For example, control of one or more factors, such as light, water flow, nutrient components, bacteria and parasites, and/or numerous other factors, either locally or remotely, allows for the providing of different growth rates to match demand, respond to issues, transition between crops, and/or otherwise optimize output of the vertical farming system 2. Further, the vertical farming system 2 allows for growth of plants out of cycle with local and remote outdoor farming. Such ability for staggered harvesting reduces crop competition both for plants produced using the vertical farming system 2 and/or traditional outdoor farming. In some embodiments, a nutrient supply and a water supply can be separated to further prevent crop disease and damage.

In some embodiments, the vertical farming system 2 includes a lighting system 40 having a light enclosure 444 including an iris, in accordance with some embodiments. In prior systems, two principle problems occur due to lighting for indoor growth efforts, mounding and decreased yield. As used herein, the term mounding refers growth of plants towards a stationary light source placed above the plants, resulting in a misshapen growth pattern. Mounding results in uneven plant growth and yield, with plant growth generally being centered largely only directly beneath the light source. Current lighting systems further produce decreased yield due to scorching, burning, or overheating of plants, root systems, and/or water. The heat from a light source may brown or kill plants closest to the light source, due, in part, to the heat emanating from the light source.

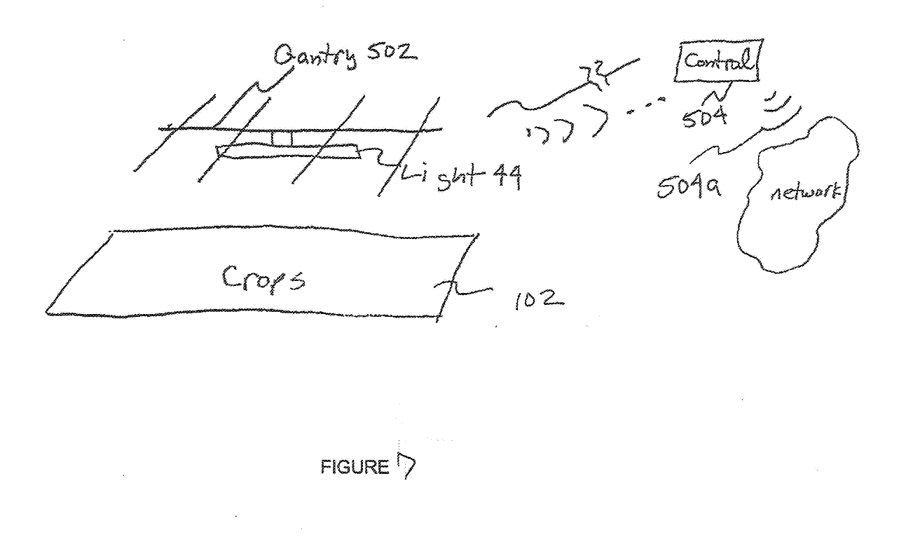

FIG. 6 illustrates a light enclosure 444 configured to prevent mounding and to increase yield as compared to traditional light systems. The light enclosure 444 includes an iris having several overlapping leaves 446, or folds. Each of the overlapping leaves 446 are configured to slidably increase and/or decrease an aperture 448 defined by the light enclosure 444. In some embodiments, the overlapping leaves 446 are mechanically actuated to increase and/or decrease the aperture 448. For example, in the illustrated embodiment, one or more flexible cables 454 are looped about the overlapping leaves 446 defining the aperture 448. In some embodiments, the flexible cables 454 include a first end looped around a respective overlapping leaf 446 and through a first opening and/or eye defined at one end of a flexible cable 454. A second end of the flexible cable 454 is looped through a second opening and/or eye associated with one or more mechanical gears. The gears are configured to pull each of the flexible cables 454 tighter through the eye, thereby decreasing (or closing) the aperture 448 of the light enclosure 444. The gears may be reversed to provide additional slack in each of the flexible cables 454 such that the aperture 448 is increased (or opened). The aperture 448 may be suitably adjusted for any number of factors, such as light to be provided to a crop, distance of the light enclosure from a crop, motion of the light in relation to a crop, heat provided by the light or to the crop, or the like. In some embodiments, the gears are integrated to a control system 460 that may include a motor, pulley, and/or other actuation mechanism and a controller.

In some embodiments, one or more internal features of the light enclosure 444, such as a portion of the leaves 446 adjacent to a light source positioned within the light enclosure 444, may be reflective and/or refractive. For example, in some embodiments, the interior of the light enclosure 444 may be 95-98% reflective and is configured to direct light from the light source through the aperture 448. In some embodiments, the light source is oriented perpendicularly to a plane in which the crops are grown beneath the light source (i.e., a plane of the flow table 20), thereby providing maximum reflection of the light source from the reflective internal sides of the leaves 446. Reflection and/or refraction allows for the use of a lower power light source, decreasing the cost of the light source as well as the likelihood of crop burning due to the heat provided from the light source. In one embodiment, the light source may be in the range of 100-500 watts, for example about 70 watts.

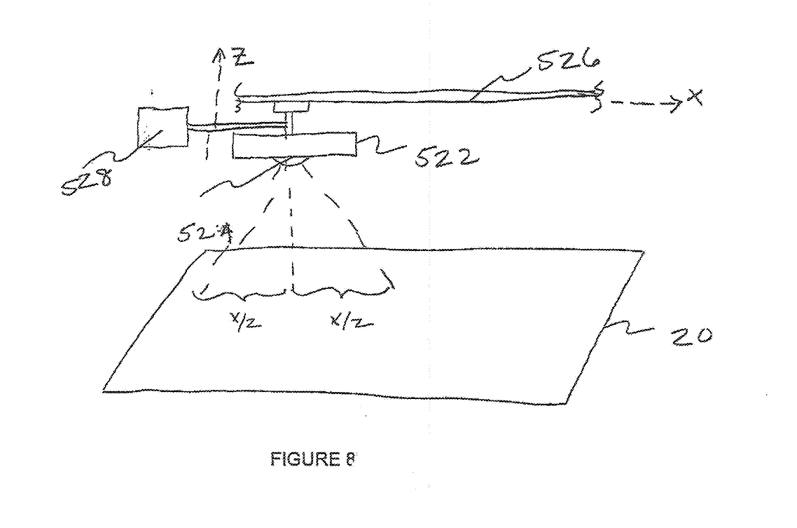

FIG. 7 illustrates a system diagram of a vertical farming system 2a including a lighting system 40a including a light enclosure of FIG. 6, in accordance with some embodiments. The light enclosure 444 is coupled to and configured to move on a mechanical gantry 502 positioned above a flow table 20 containing a plurality of crops 102. The light enclosure 444 may be moved in a predetermined pattern, for example, dependent upon crop type. For example, movement of the light enclosure 444 on the mechanical gantry 502 may be controlled by one or more automated control systems 504. The control system 504 may be the same as and/or distinct from the control system 460 coupled to the light enclosure 444. The control systems 504 may include, for example, one or more local programmable logic controllers, which may be associated with one or more local or remote network controllers.

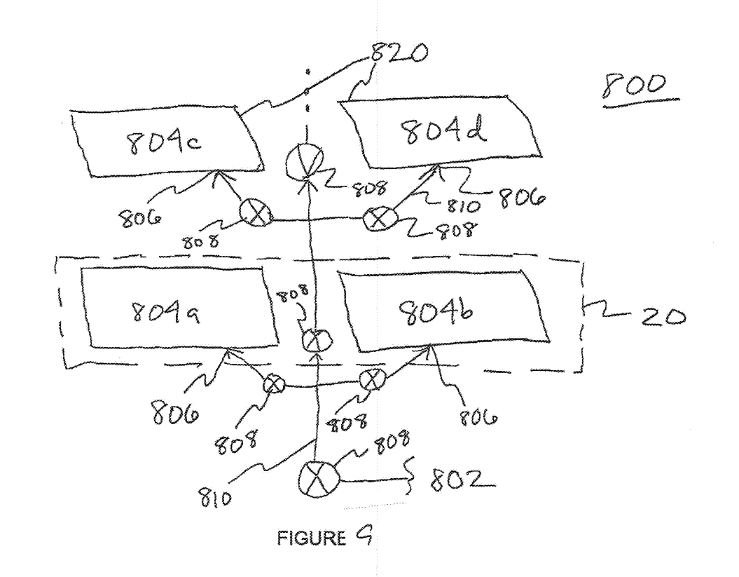

FIG. 8 illustrates a lighting system 520 having an illumination distance X, in accordance with some embodiments. The illumination distance X is the distance between the light source 524 and the flow table 20. The illumination distance X may include any suitable distance, such as, for example, about four feet from the center of the light source 524 to the flow table 20. In some embodiments, the light source 524 is configured to traverse in an automated, predetermined, and/or timed fashion along the X-axis 526. The light source 524 may further be configured to adjust the illumination distance along a Z-axis, for example, using a manual and/or automated Z-axis adjustment 528. In some embodiments, the light source 524 can be adjusted on both the X-axis and the Z-axis.

Adjustment of the light on the X-axis and/or the Z-axis prevents damage to the plants caused by heat and/or excess light. Moving the light source 524 ensures the light source 524 is positioned at a proper height from each particular plant prevents over delivery of heat to the plant, while optimizing light delivery to each plant. Further, movement of the light source may assist in maintaining water temperature at a low value which, as discussed above, minimizes adverse effects of lighting on the plants.

In some embodiments, remote control of the lights, such as via at least one network, may allow for purchase by a grower, lease to a grower, or provision to a grower using a “light subscription”. In a subscription based model, a purchaser may receive lights akin to those disclosed herein, wherein the purchaser may pay for the amount of light used, or may pay for the value of the lights themselves over time, wherein the lighting may be tracked using, for example, the network communications of the lighting system disclosed herein. Moreover, a provider of the lights to the leasee may insure against the loss of the lights, and may additionally monitor the use of the lights for compliance with a subscription agreement. In some embodiments, financing may be provided pursuant to a leasing or subscription model.

In some embodiments, a vertical farming system 2a includes networking capabilities 504a configured to allow for both financial and insurance models to be employed. Networking capabilities 504 may further allow for remote monitoring and programming, such as to match lighting to a particular crop, or to monitor for acceptable operation of the lights or to prevent damage to crops.

Additional features might be added to both the motion aspects and the light providing aspects of a vertical farming system 2a, such as in order to optimize crop yield. For example, motion algorithms may be modified over time as optimal motion is learned, such as via the aforementioned monitoring, for particular plant types. Additionally, features such as a randomizer may be added to avoid hot spots that may damage growing crops.

Moreover, because the lighting controls may be wirelessly networked and may thus be capable of wireless communication, the network may provide for additional sensing, such as including light temperature and room temperature. Moreover, wireless lighting controls may allow for the creation of a mesh network using the lighting controls, which may additionally allow for control of individual light aspects via one or more wireless technologies, such as via a mobile device app.

In some embodiments, the turbulence of a cross flow across a flow table 20 may be increased to provide optimal re-oxygenation of a water flow. In some embodiments, multiple drains 24 are provided to accommodate said cross flow. Safety shut off valves may be provided in association with one, some, or all drains 24 to prevent drain jamming and flooding. For example, in some embodiments, between 9 and 11 drains 24 may be provided in each flow bed 20. The drains 24 may be positioned in a staggered manner to ensure that some water flow is maintained at a proper minimal level to optimize plant growth while preventing overflow. In some embodiments, the drains 24 may operate as Venturi drains, i.e. as siphons, thereby maximizing oxygenation of the water.

In some embodiments, the multiple drains 24 are configured to force the plant roots to “stretch” towards the water so as to provide aeroponic growth and optimization of plant health, as discussed further herein below. In some embodiments, the multiple drains 24 allow for high flow and high turbulence break up of anaerobic bacteria, i.e. scum, thereby optimizing crop yield and plant health.

As illustrated in FIG. 9, in some embodiments, a vertical farming system 800 includes a highly modularized system of both water supply 802 and flow tables 804a-804d. The vertical farming system 800 is similar to the vertical farming system 2 discussed above, and similar description is not repeated herein. As referenced herein, modularity encompasses pre-manufactured assemblies that are assembled on site at a growth facility, including preconstruction to allow for expedited assembly of a prefabricated growth facility on site. The vertical farming system 800 includes a partial rack of 4-foot by 4-foot flow tables 804a-804d each on approximately eight foot table shelf 820. As will be understood, each shelf 820 of flow tables 804a-804d thus provides a 4-foot by 8-foot growing area, with each pair of growing trays providing modularized units. Further, and as shown, each 4×4 tray is provided with a water inlet 806, such that each shelf 20 includes two valves 808 and two inlets. The water supply to each flow table 804a-804d, each shelf 20, or sets of shelves may be activated or deactivated by optionally opening or closing individual valves 808. As such, a growing unit, such as an 8-foot rack having four shelves 20, may be modularly deployed or deconstructed.

In some embodiments, the vertical farming system 800 includes a plurality of pipes 810 configured to be coupled via a threaded connection and/or via compression such that the pipes 810 can be releasably coupled to and/or disconnected from a corresponding inlet 806 or valve 808. The releasable pipes 810 allow elements, such as pipes, trays, etc., to be swapped in and out of the system 800 in real time, such as for cleaning and re-swapping at a later point in time, such as monthly. Such maintenance may be performed in, for example, one hour or less. Further, the disclosed modularity may allow for construction of an eight foot rack of shelves 20 in approximately one to three hours or less. The lack of glue avoids the growth of anaerobic bacteria, thereby improving plant health and growth rate.

In some embodiments, the modularity of the vertical farming system 800 facilitates cleaning of pipes and/or trays in a common dishwasher, using peroxide based cleaning, and/or with simple water steam, by way of non-limiting example. This may allow for in situ cleaning of certain modular aspects of the vertical farming system 800, due to the ability to effectively disconnect preselected modules from the water supply.

In some embodiments, the modular maintenance and cleaning discussed herein may additionally aid in pest elimination. For example, mold, mildew, humidity, standing water, and the like, that may attract pests may be eliminated through the regular maintenance and cleaning provided by the vertical farming system 800. Pest elimination may be further supported by constant movement of air and quarantines on entering products and equipment as discussed herein. The use of the vertical farming system 800 eliminates the use of pesticides such that the 50 days typically necessary for a pesticide to grow out of the plant is eliminated. As such, the expedited harvesting methods discussed throughout in conjunction with the advance growth rates referenced herein further support a pesticide free environment.

The placement of each flow table 804a-804d or pair of flow tables 804a-804d per shelf 820 on one or more low profile pallets may allow for ground based harvesting, which is an additional efficiency provided by the vertical farming system 800. For example, a low profile pallet may be fork lifted to ground or table level in order to plan or harvest each individual 4×4 modular flow table 804a-804d, such as after any water supply has been disconnected from the respective tray. As such, in a first step a given flow table 804a-804d may be disconnected from the water supply using the disclosed valves, which consequently allows for the water in the flow table 804a-804d to empty. As a second step, a forklift may then be used to move the pallet upon which a respective flow table 804a-804d rests to a harvest or planting table. After harvesting or seeding occurs, the same forklift may lift the low profile pallet and modularly replace the flow table 804a-804d, at which time the water supply may be reconnected and water may flow. As such, harvest and plant teams may be uniquely created, and downtime for harvesting or planting may be on the order of minutes rather than hours, while the risk of falls, ladders, and the attendant risks in using scissors lifts and the like is avoided.

Thereby, the disclosed embodiments may provide hot swappable, scalable, and/or fully modular, closed indoor farming systems. The flow table 804a-804d may come on and off independently in a single vertical farming system 800, thereby providing scalability and team-based, highly efficient indoor farming.

Further and to optimize and provide process refinement, the vertical farming system 800 may provide unique piping in the modular aspects of the embodiments. The unique piping may allow for enhanced flow, such as to allow full water exchange on all trays of a full rack in one to two minutes or less, which all but precludes the growth of anaerobic bacteria.

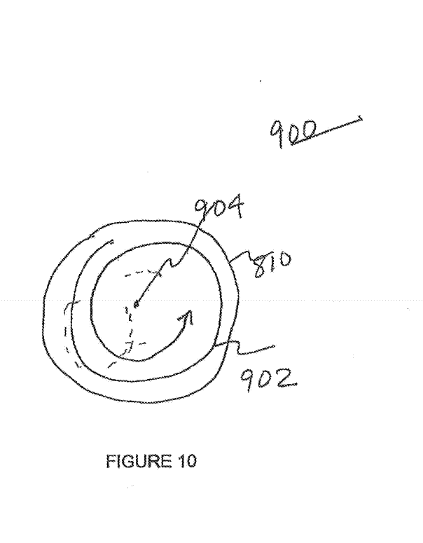

In some embodiments, the piping 810 of the vertical farming system 800 may allow for the creation of a Venturi pressurized system 900 as illustrated in FIG. 10. Each of the flow tables 804a-804d includes a plurality drains 24, which allows for increased water flow across each flow table 804a-804d. The increased water flow, upon reaching downward drain piping, creates a multiplicative spiral 902 within the pipe as illustrated in FIG. 10. The multiplicative spiral 902 enhances the surface area on the outside of the flow and creates an air pocket 904 in the center of the pipe as shown, thus creating a Venturi flow that exposes more of the water to oxygen, enhancing the amount of oxygen that enters into the water. Oxygenation of the water may be further enhanced by, for example, pressurizing the water in the pumping base tank (as discussed above) with additional oxygen and/or increasing the turbulence of the water in the base tank, such as with fans or blowers, by way of non-limiting example.

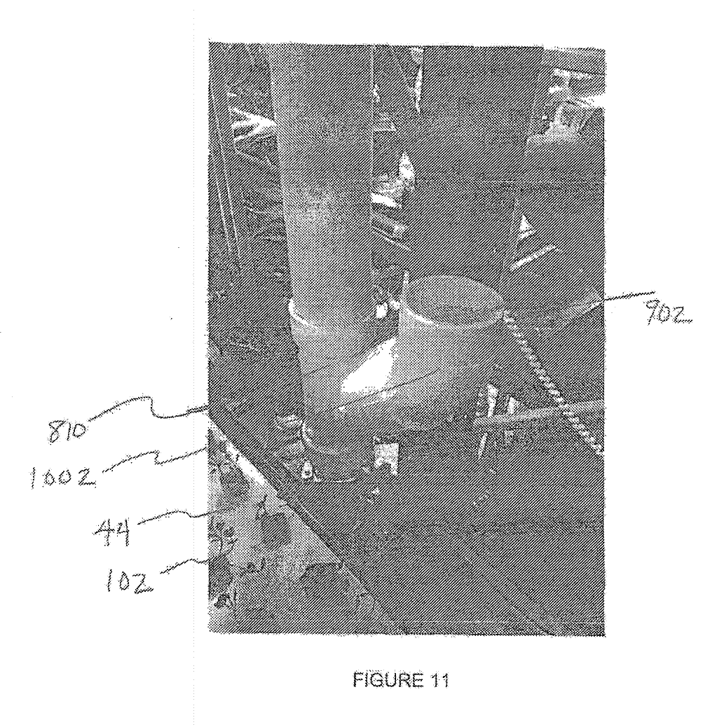

As illustrated in FIG. 11, in some embodiments, the modularity of the piping 810, in conjunction with the Venturi flow within the downward pipes, may readily allow for the location of high-mixing nutrient inputs 1002 along the downward piping, such as whereby nutrients may be readily entered into a nutrient input, mixed by the Venturi flow for entry into the tank, and subsequently pumped back upwards into each modularly operable flow table 804a-804d.

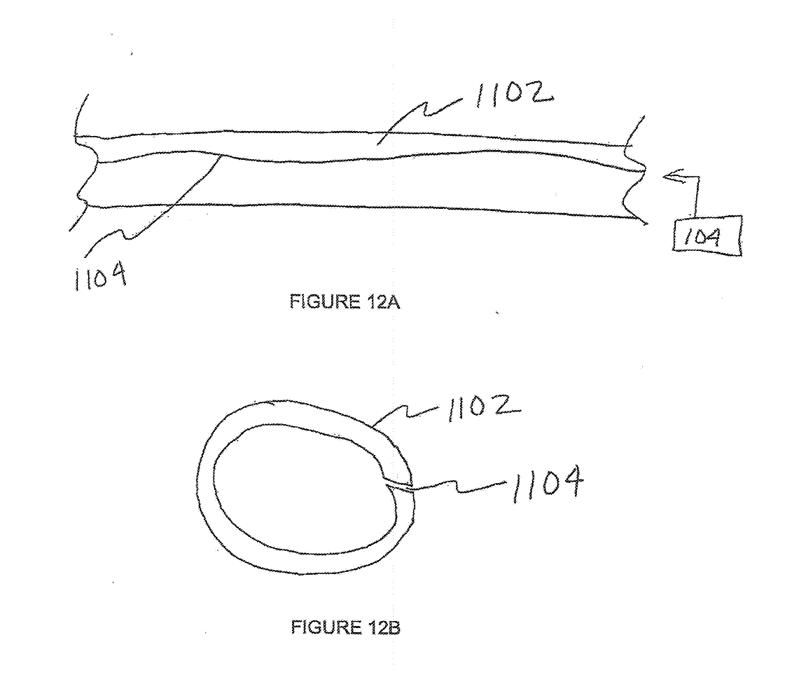

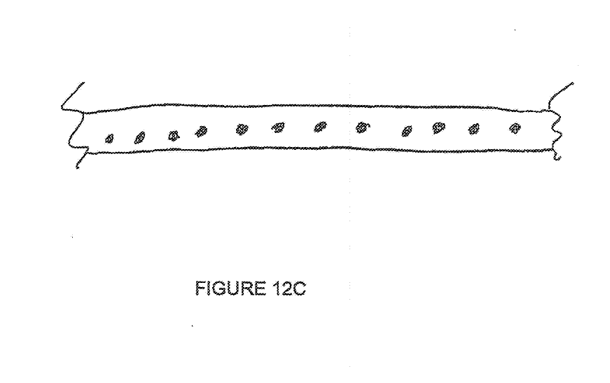

As illustrated in FIGS. 12A and 12B, in some embodiments, the vertical farming system 800 includes spray bars for providing water from the water inlet 104 into each tank, in accordance with some embodiments. The spray bar inlets 1102 may, in some embodiments, have a slit 1104 running lengthwise and at one or more tangent points on the circumference of the spray bar 1102. More particularly, the slit 1104 may run the full and/or partial length of the spray bar, may or may not be uniform from the center point of the mean high water line on the pipe along the length of the spray bar, and may or may not be comprised of a uniform cut or cuts, both in cut size and/or cut angle, along the length of the slit 1104. The slit 1104 generates a uniform water spiral within the spray bar 1102 prior to exit of the water from the slit 1104, providing enhanced water flow uniformity across the flow table 804a-804d and increases turbulence in the flow within the spray bar 1102 to additionally enhance the water content of the water flowing across the flow table 804a-804d. FIG. 12C illustrates an embodiments of a spray bar having a plurality of openings.

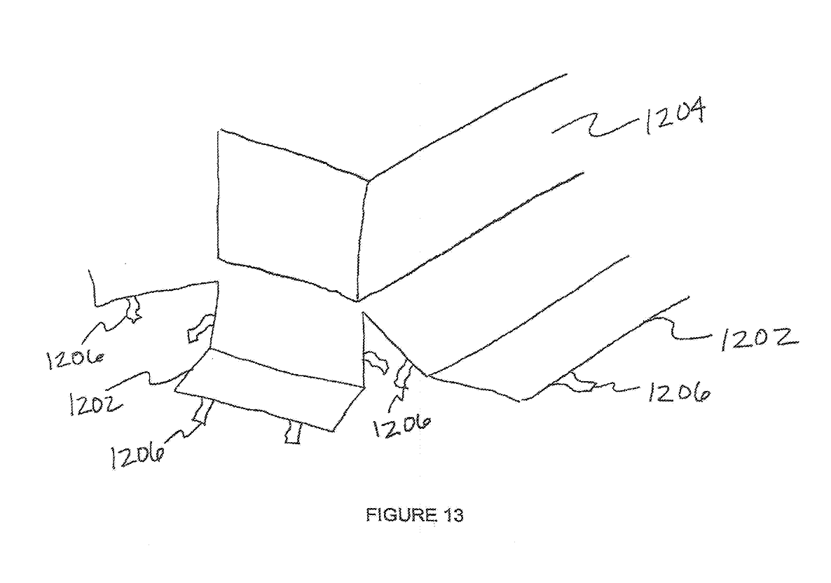

Further and by way of non-limiting example, maintaining the water in supply tanks at a low temperature, such as 68°, may further prevent overheating of plants, including by serving as a heat sink for the room. To minimize the possibility that the water temperature will be undesirably raised, FIG. 13 illustrates a tank cover 1202 that may protect the tank 1204 from gaining or losing heat, and that may be comprised of heat reflective material, such as that included in oven mitts. The tank cover may additionally have hook-and-loop, or a like ready-fastener/unfastener 1206, to allow for simplistic attachment of the cover 1202 to the contours of the tank 1204, and which may further allow for simplistic removal of the cover 1202 from the tank 1204, such as to allow for washing of the cover 1202.

The controls and sensing discussed throughout may further include optimization of the enthalpic moment for the growing environment. That is, various embodiments of the vertical farming system 800 may, using each individual plant and algorithms specific to certain plants and environments applied by one or more computer processors, provide an optimized window of a plant's needs for optimized growth. In short, an optimized enthalpic moment may have a large number of contributing variables, but principal among these variables are water (which includes bacteria and nutrients), CO2, and light. Through assessment of variables correspondent to at least the foregoing three, and, in preferred embodiments, additional variables, the algorithms may correlate the variables over a particular range to obtain an enthalpic moment of optimized growth for individual plants. Such calculations may additionally include, by way of example, the energy provided by manual laborers typically present in a room, energy provided by computers in a room, energy produced by light wattage, energy or gases absorbed by enhancing turbulence in water flow, and the like.

Manipulation of variables to obtain an optimal enthalpic moment may allow for minimization of the use of heating or air conditioning in a given environment. For example, in light of a plant's needs, variables may be controlled with a target point for environmental temperature and humidity. Maintenance of temperature and humidity at a preferred steady state, while providing at least minimum quantities of water, CO2, and light, may optimize plant yield and minimize failures.

Accordingly, while sensors may be used to provide data to one or more computer processors applying the disclosed algorithms a current state of each of the variables discussed herein, environmental definition and control may be modified from the known art. For example, environmental controls may be defined by an enthalpy factor, wherein the environment is to be maintained for optimal plant growth within a particular tolerance of a given enthalpy factor for the growing then underway.

Further, the use of an enthalpy factor allows for the definition of an energy value on a per plant basis to maintain a given enthalpy factor. Such energy value may include, by way of non-limited example, the capture of heat by each plant from one or more lights to which the plant is subjected, the effects of sunlight on energy consumption on a per plant basis if lights are only used periodically or at night, and stray energy within a room that may be captured and rededicated to plant growth.

As additionally referenced herein, the interconnectivity, such as via a mesh network, of a growth facility in accordance with the embodiments may allow for generation of significant data sets, which enable expedited artificial intelligence learning capabilities. That is, to simply maintain temperature and humidity in a typical growth facility, 5 variables must be monitored manually. The three-dimensional data set generated by the embodiments allows for automated learning to balance and weight these 5 variables, such as on a plant by plant or facility by facility basis, in order to uniquely optimize growth for each plant and each facility. These significantly advanced data sets, which may be accumulated across multiple facilities, such as tracked by facility and/or plant growth type, allows for nearly unlimited scalability in the embodiments. The scalability allows for expedited timing to get a growth facility up and running, and, such as in conjunction with the pesticide free growth discussed herein, and the modularity discussed herein, can allow for tripling or quadrupling of yield per square foot in a facility as a consequence of the scalability and upward build of the modular platform provided herein.

These advanced data sets may be generated by mesh, Raspberry, or similarly interconnected networked elements. Such elements may include, for example, stationery, movable, or drone based cameras, such as visual spectrum or infrared cameras, that allow for data tracking of plants in various locations and at varying heights; device timers; air-conditioning and humidity control; pumping and water chilling; lighting, and so on. In conjunction, these data sets may allow for pattern recognition by the artificial intelligence provided in accordance with the embodiments. This pattern recognition may allow for modification of any one or more variables to achieve desired results for particular plants, particular facilities, and so on.

In some embodiments, water-based chillers may be employed, such as to distribute chilled water to the reservoirs discussed herein, and to at least partially control air temperature in the facility. The use of chilled water may decrease the BTUs necessary to cool a facility by 5 to 10 times. Further, additional data points made available by the use of water chillers may include known humidity in a facility based on plant transpiration, as the use of chilled water results, in part, in the removal of humidity from a facility thereby allowing for an indication to the artificial intelligence that remaining humidity in the facility is being generated principally or solely from plant growth. Of note, the chillers discussed herein may be solenoid based, and solenoid's may be distributed as between multiple tanks, or may be resident only in, for example, a center tank among 3 tanks. Longer solenoids are desirable, at least in that the additional surface area generated by a longer solenoid, such as more of the water surface, thereby resulting in enhanced chilling.

In some embodiments, the distribution of chilled water, such as is referenced above, further allows for control of plant growth. For example, in some embodiments, the chilled water provides “air-conditioning” at the roots of the plants that extend down into the tanks containing the distributed chilled water, allowing for temperature and transpiration monitoring of the plant, to thereby allow for a correlation of plant health, transpiration, and system operation. This correlation may include, for example, all data points available on the platform, including those generated by the hardware discussed herein, such as by drones, cameras, infrared, or the like. The use of infrared monitoring may allow, for example, as part of this calculation, the generation of BTUs by people within a facility, the monitoring of the temperature and amount of airflow, and the infrared monitoring of lights, water, and other elements that provide a temperature indicative of proper operation.

In some embodiments, a vertical farming system 800 can be configured for optimized water growth, including in the use of rapid deep water culture. For example, a check valve may be included, such that when, based on the modular piping provided, a pump is turned off, water is blocked from siphoning from the upper trays back into the tank, thereby preventing plant damage. This check valve may operate based on the physics of the water flow as the siphon against a form, or may include an automated valve that is actuated by the system based on a pump shutdown. The check valve employed may be, for example, a 2 psi check valve.

Further, lights may be variously controlled to allow for deep water growth. For example, lights may automatically move up, down and sideways, and may provide for multiple planes of plant growth through the use of variable lighting. Additionally, multiple lights may be simultaneously or hierarchically employed.

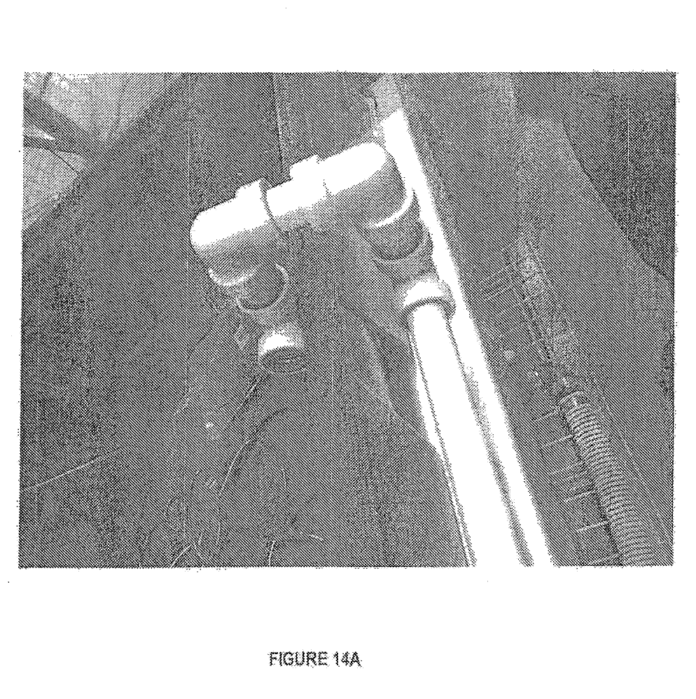

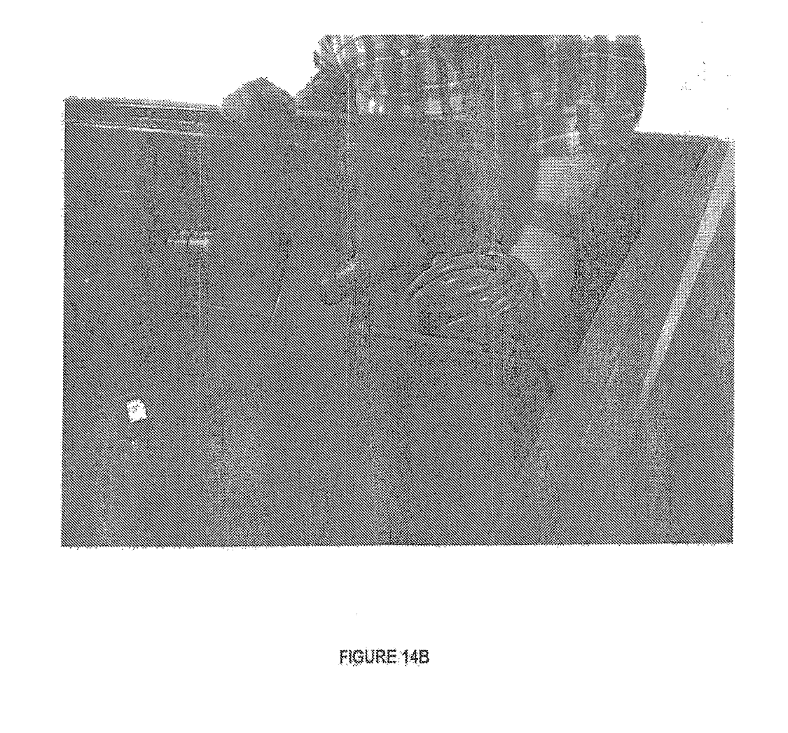

In some embodiments, water controls may be provided specifically for rapid deep water culture growth. For example, water inlets may be provided with rotatable piping, such that the water may be aimed upon inflow to cause root growth in a particular direction, such as to avoid the blockage of drains. Likewise, one or more directional drains may be provided in order to “aim” drains away from root growth, such as away from the directionality of the inlet water. FIGS. 14A and 14B illustrate rotatable water inlets, and drains, respectively, that allow for manual water flow control.

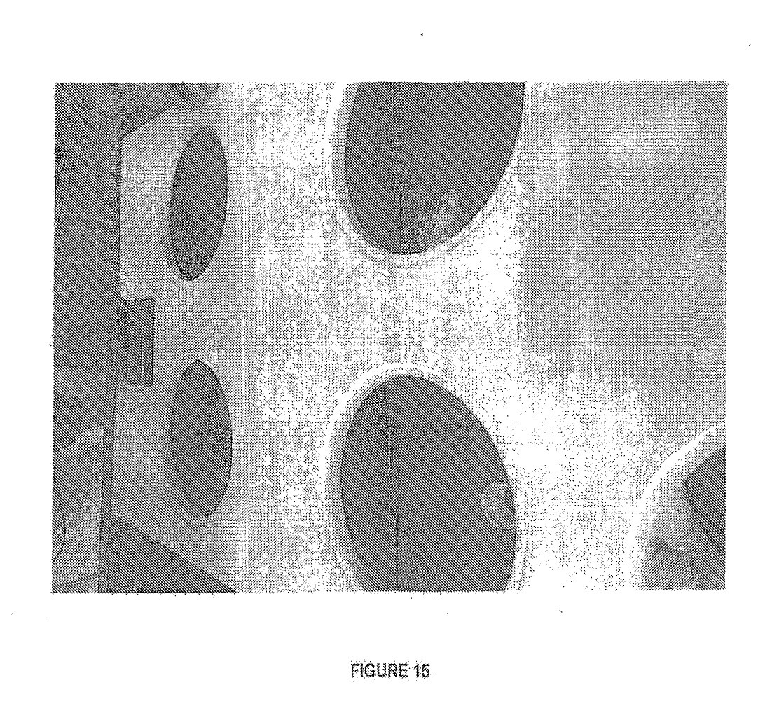

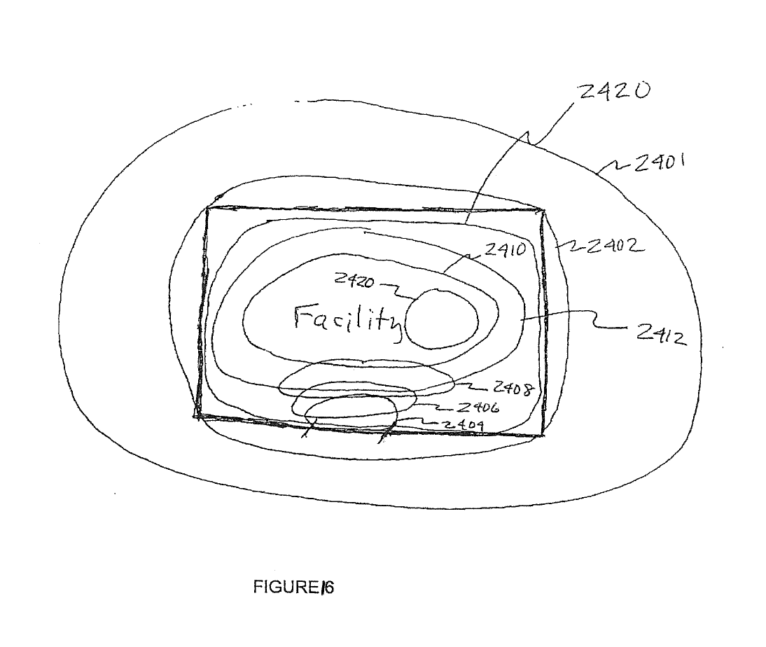

FIG. 15 illustrates one embodiment of a “growth board” that may or may not float atop the water as disclosed herein, but that includes one or more cutouts. These cutouts may allow, by way of non-limiting example, for the insertion of a hand in order to manually rotate the inlet and/or drain piping as discussed above. Of note, plants that may be subjected to rapid deep water culture growth may include, by way of non-limiting example, sunflowers, tomatoes, cannabis, peppers, poppies, and so on.

In some embodiments, a pesticide, fungicide, and herbicide free environment may be created by the conceptual creation of anti-pest “zones” beginning outside of the growing facility 2401, 2402 and terminating at the point of growth, as shown in FIG. 16. For example, anti-pesticide paint may be used outside and inside of the growth facility. Upon entry to the growth facility, a person may be subjected to a vestibule 2404, such as may douse the person with water, high-pressure air, physical brushing, or the like. This vestibule may also be a zone 2406 for changes of clothing for the entering person. Furthermore, the vestibule may include one or more “blue lights”, or similar lighting 2408, to kill and/or help with the detection of pests.

Once departing the vestibule, the person may enter an organism-based clean room 2410. No food or drink may be allowed in the clean room, and the temperature control may be comfortable for plants and people, but may be adverse to pests, such as based not only on temperature, but also on humidity. Such growing methodologies may additionally allow for kosher and/or medicinal growth. For example, the vestibule mentioned above may include a changing room that may include a shower, the need for a person to clothe him or herself in a bunny suit, hair covering, negative airflow, laundry services, and so on. Also included may be particular filtration systems 2410, such as ozone, CO₂, carbon based, HEPPA, and the like, which may not only eliminate pests but may additionally aid in plant growth.

In addition to climate controls, once a person is within the growing area, other pest elimination techniques 2420 may be employed. For example, the anti-pest paint mentioned above may be used, as may be sticky pads to capture pests, nematodes to kill bug eggs, plant friendly killer bugs, such as lady bugs and praying mantis, and terminator plants, such as may eat pests. It goes without saying that certain of the foregoing, such as nematodes, killer bugs, and terminator plants may require replacement at regular cycles due to a lack of food if the environment is indeed maintained as past free.

In some embodiments, the vertical farming system 2 is configured for micro-climatization and/or micro-control of one or more growing environments. A refined temperature and humidity control systems may be used in conjunction with a lighting system, such as the lighting systems 40, 40a described herein in predetermined portions of a growth environment. For example, in some embodiments, humidified and/or dehumidified micro-environments are provided within the same growth area. As another example, in some embodiments, high-light, low-light, and/or multiple light cycles are provided within the same growth area.

In some embodiments, a control system, such as one or more of the control systems 460, 504 discussed above, is integrated with one or more sensors and/or sensing systems configured to monitor temperature, humidity, infrared (e.g., heat), and/or other environmental factors in one or more predetermined micro-environments (or pockets) within the growth environment. The control system is configured to provide monitoring of the growth environment and/or predetermined micro-environments within the growth environment based on input from the one or more sensors and/or sensing systems. For example, in some embodiments, one or more sensors, such as infrared cameras, are configured to monitor infrared output (e.g., infrared signatures). The input from each sensor is processed by the control system to identify infrared signatures associated with individual insects and/or insect nests. Although specific embodiments are discussed herein, it will be appreciated that the control system can be configured to monitor any suitable input for identifying any suitable parameters, such as, for example, plant health, insect presence, crop yield, etc.

In some embodiments, the control system is configured to apply one or more data manipulation techniques to refine input from the one or more sensors and/or sensing systems. For example, in the embodiment discussed above including infrared monitoring for insects, the signal to noise ratio of the data generated in comparison to the data signifying an insect may be high. Eigen-value or Eigen-vector manipulation may be performed on data received from the one or more sensors to identify the data representative of (or significant to) an insect or insect nest.

In some embodiments, the control systems is configured to use a combination of micro-data (i.e., data pertaining to one or more micro-environments) and macro data (e.g., data pertaining to the entire growth environment) to monitor the growth environment and/or the micro-environments. For example, macro data may be used to analyze the presence of people, the temperature of a given set of plants, or the like. Micro-data may be used to assess the presence of bugs, the presence of warm-blooded and/or cold blooded creatures, or the like. A combination of micro and macro filtering may be employed to assess, for example, humidity and temperature, including microclimate and/or macroclimate humidity and temperature.

In some embodiments, the control system and associated micro-environments discussed herein allow various greenhouse environments to be selectively provided within the growth environment, for example, within only one or more micro-environments. In some embodiments, the lighting system 40, 40a is configured to provide light within one or more micro-environments according to a predetermined schedule, such as, for example, only during hours of darkness. In some embodiments, the vertical farming system 2 is configured to block light from passing through particular greenhouse panels (or into portions of the macro-environment), for example, by using shades, glass darkening, and/or other light blocking techniques. The control system can be configured to selectively darken micro-environments within the macro-environment while allowing light to pass through other greenhouse panels and/or portions of the greenhouse. Further, humidity and temperature may be controlled and modified in conjunction with one or more macro-environment controls, for example, covering/uncovering and/or opening/closing of greenhouse windows. Each microclimate and/or macro growth environment may be treated as one or more closed systems, in which the growth of one or more plants may be monitored and controlled. In various embodiments, the control system is configured to control one or more micro-environmental controls, one or more macro-environmental controls, and/or a combination of both micro and macro-environmental controls.

In some embodiments, the macro-environment includes a plurality of micro-environments each corresponding to one or more layers within the vertical farming system 2. For example, a canopy provided by an upper-level growth may minimize the passage of light to and decrease the temperature of lower growth climates in a multilevel vertical farming system 2. The control system may be configured to isolate micro-environments within the vertical farming system 2 to advantageously position one or more crops in view of environmental performance, such as with respect to humidity, based on the choice of crops placed at each level of the vertical farming system.

In some embodiments, the use of micro-environments provides an increase in harvest per square foot within the greenhouse macro-environment as compared to existing basic greenhouse environments. The micro-environments may be maintained with little to no additional energy or costs as compared to the energy/cost necessary to obtain the (decreased) harvests available in basic greenhouse environments. In some embodiments, the control system and/or the vertical farming system 2 include additional system configured to assist in maintaining one or micro-climates, such as the use of cool groundwater (approximately 57°) as a natural chiller system, artificial lighting that generates little to no heat, and/or other systems configured to allow the establishment and maintenance of micro-environments. As one example, the use of cool groundwater helps to maintain water distributed to plants at an optimal temperature, such as 68°, to provide for optimal growth without the need for a refrigeration/chiller systems. In another example, low-heat artificial lighting may be employed during darkness, or like deprivation periods, to avoid the need for cooling the ambient environment.

As discussed above, in some embodiments, the vertical farming system 2 includes a modular system configured to allow for regular maintenance cycles. For example, a vertical farming system 2 including modular pipes allows for removal and cleaning of certain pipes without the need to use harsh chemicals and/or shutdown entire sections of the vertical farming system 2. The modular system allows for more frequent maintenance, and hence cleaning, and provides a consistent maintenance cycle over a longer period of time. A vertical farming system 2 including one or more modular systems allows for the maintenance of a vertical farming facility without decay using simplistic and expedited cleaning at minimal cost.

In some embodiments, the use of microclimates, in conjunction with the variable maintenance cycles provided by a modular vertical farming system 2, provides for the development of unique strains of crops optimized for growth within a vertical farming system 2. For example, refined control of insects, humidity, temperature, nutrients, carbon dioxide, water and/or other environmental factors within each of a plurality of microclimates allows for the matching of crops to the environment within each microclimate of the vertical farming system 2. As such, crop strains may be optimized or modified to match up with a given growth microclimate targeted to maintain optimized performance for that crop strain.

As illustrated in FIG. 16, in some embodiments, the vertical farming system 2 can include one or more chillers configured to maintain an optimal water temperature for one or more microclimates and/or macroclimates within the vertical farming system 2. An optimal water temperature may be, for example, a water temperature between 62 and 74°, such as about 68°. In some embodiments, one or more chillers include one or more coils each thermostatically controlled by a solenoid positioned within a water tank and/or nutrient bath, such as within the water tank 12 of the vertical farming system 2. In some embodiments, the vertical farming system 2 may include one or more water tanks 12 configured to provide a nutrient solution to an associated one of the microclimates within the vertical farming system 2. Each tank 12 may be associated with a growing rack, a portion of a growing rack, and/or multiple growing racks within the vertical farming system 2. The solenoid may include any suitable solenoid configured to maintain the temperature of a nutrient bath solution within the water tank 12 at a predetermined temperature, For example, the solenoid may include one or more of a spring coiled solenoid, a corkscrew solenoid, and/or any other suitable solenoid. The solenoids may extend substantially across opposing sides of the tank 12 to prevent the creation of temperature pockets.

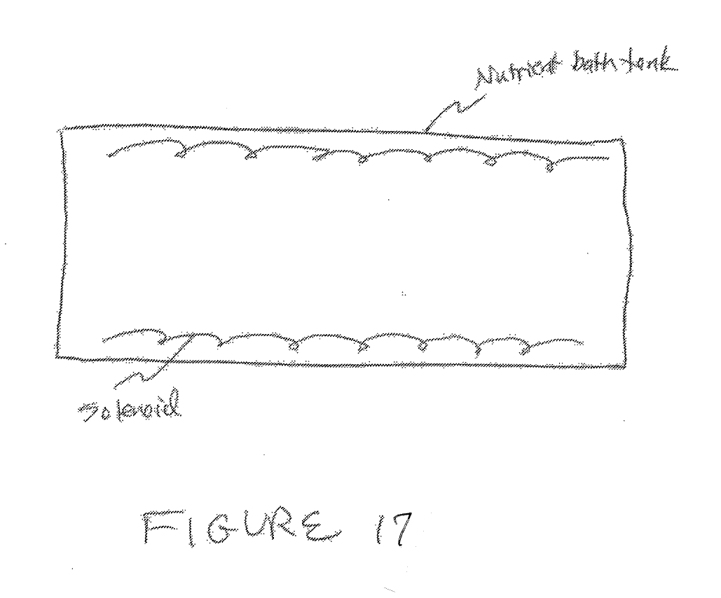

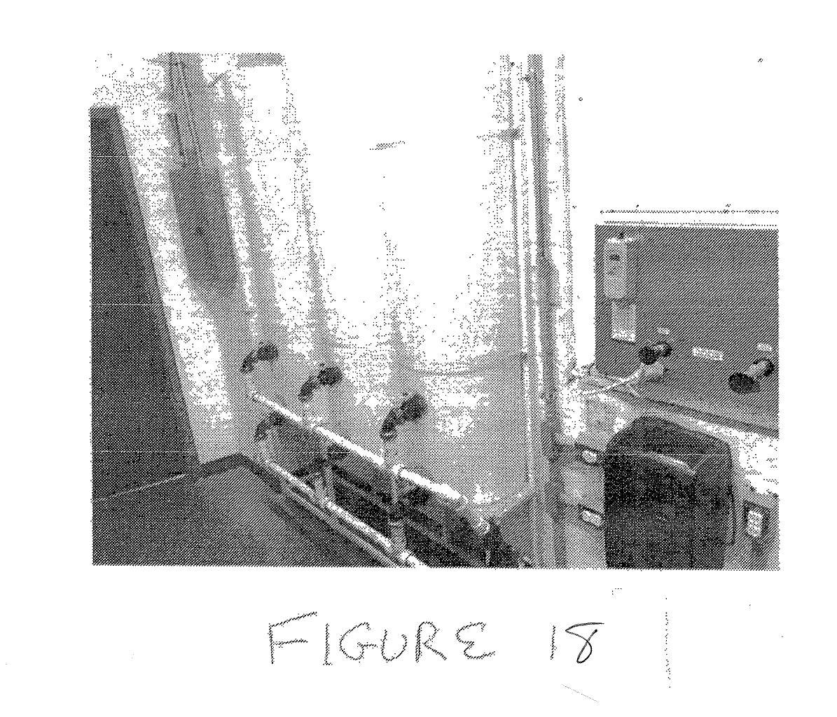

As illustrated in FIG. 17, in some embodiments, a chilling system is positioned remotely from one or more water tanks 12. Each of the water tanks 12 is coupled to the chilling system by a return line extending from the tank 12 to the chilling system. In various embodiments, decoupling pipes, decoupling reservoirs, and/or any other suitable decoupling system may be employed. As illustrated in FIG. 17, decoupling reservoirs may be coupled to a chilling system and configured to provide a one-to-one, multi-to one, or one to multi-relationship between one or more chilling systems and/or one or more decoupling reservoirs. Moreover, the disclosed system may allow not only for the chilling of water, but the warming of water using the same system as disclosed throughout. In some embodiments, the use of decoupling reservoirs enables leak assessment, for example, by adding coloring to one or more decoupling reservoirs to identify the source of a leak.

In some embodiments, the chilling system decoupling reservoirs, and/or other elements of the vertical farming system 2 provide a closed system configured to maintain a constant pressure. Pumps, valves, and/or other elements may be employed to adapt to environmental changes, such as temperature changes, to maintain the pressure within a water-delivery system at a constant pressure. Additional benefits may be provided by a closed system, such as substantially accurate humidity control, reduction or elimination of backflow, and/or other advantages. For example, a closed system that includes dehumidifiers may allow for the removal of humidity as needed in order to maintain a particular humidity set point. Although specific embodiments are discussed herein, it will be appreciated that the vertical farming system 2 can include any suitable elements to maintain a closed water system.

In some embodiments, to further decrease power consumption, improve lighting efficiency, and/or protect crop growth in an indoor farm, the vertical farming system 2 may include an electronic ballast and lamp system for controlling power to one or more lamps, such as, for example, LED, HID or gas discharge lamps. Although specific embodiments are discussed herein, it will be appreciated that the any suitable light element may be used in conjunction with the vertical farming system 2 and is within the scope of this disclosure. As used herein, the term “ballast” refers to a circuit or circuits configured to regulate one or more electrical parameters, such as voltage, current, power, etc., provided to one or more lighting elements or lamps. Existing ballasts and gas discharge lamps may waste energy and damage crops through excess heat generation, as discussed above.

In some embodiments, the electronic ballast and/or lamps discussed herein provide a lower temperature, a longer lifespan, and a brighter light while using less electricity. In some embodiments, the electronic ballast greater control of one or more lamps as compared to prior systems. The electronic ballast can be configured to dim one or more lamps, delay power-up to improve lamp life, sense lamp burn-out/failure, respond to lamp failure by reducing power and/or shutting down portions of a lighting system 40, 40a, be controlled remotely or by a programmable unit, and/or otherwise provide detailed control of each of the lamps of a lighting system 40, 40a. In some embodiments, the use of the disclosed ballast and lamps prevents heating of crop by using low-power light elements that do not produce significant heat.

In some embodiments, the lighting system 40, 40a includes one or more lighting elements having unconnected single electrodes (such as one or more gas-filled tubes having unconnected single electrodes (i.e., fluorescent lighting) and a ballast with electronic circuitry and related components. In some embodiments, the lighting system 40, 40a, such as the ballast, is configured to receive an A.C. input and generate one or more it D.C. outputs to power the lamps and/or other circuitry. In some embodiments, the ballast includes a doubler circuit configured to generate a high-voltage D.C. signal configured to supply power for one or more lamps. In some embodiments, the lighting system 40, 40a is couple directly to one or more D.C. inputs configured to provide the required D.C. signals.

In some embodiments, a D.C. voltage signal, such as a high-power D.C. voltage signal, is provided a plurality of Metal Oxide Semiconductor Field Effect Transistors (MOSFETs). The plurality of MOSFETs may be controlled by a Pulse Width Modulation (PWM) circuit configured to output two pulse trains 180 electrical degrees out of phase with each other. In some embodiments, the PWM circuit controls switching circuitry to switch the plurality of MOSFETs such that a high frequency output is provided to one or more output transformers. An output of each of the transformers is provided to one or more lamps having a plurality of unconnected single electrodes (e.g., two unconnected single electrodes). The PWM circuit thus controls the frequency of the voltage that is supplied to the lamps.

In some embodiments, the electrical characteristics of the ballast circuit are selected to provide one or more predetermined features. For example, the electrical characteristics of the ballast circuit enable the transformer to operate in a “high frequency zone” where an increase in frequency, with voltage held nearly constant, will cause a decrease in output current. Operation in the “high frequency zone” allows for the ballast to dim one or more lamps by increasing a frequency of the provided voltage signal. As another example, when the transformer is operated in the “high frequency zone,” the reactance values of the transformer primary windings and the transformer secondary windings become significant. Because reactance is proportional to frequency, with a steady state operating frequency of about 38 kHz, the reactance values are large. In some embodiments, the impedance of each lamp is included in the overall impedance reflected back to the plurality of MOSFETs. As current to the one or more lamps increases, the resistance of the lamp decreases allowing for a further current increase. The overall impedance of the output transformers coupled with the impedance of the lamps during a frequency change acts to limit the lamp current. A different, steady-state operating point for current and frequency may be achieved at a nearly constant voltage for each lamp used with the lighting system 40, 40a. The disclosed ballast circuit allows for a plurality of various lamp loads to be powered without rewiring and/or component change.

In some embodiments, the lighting system 40, 40a is configured to dim one or more lamps by increasing a frequency of the voltage signal provided to the transformers, causing the output current to decrease while maintaining a constant voltage. As the current decreases, the lamps dim In some embodiments, the lighting system 40, 40a operates with a higher efficiency than conventional lighting systems, as the lighting system 40, 40a operates at a higher frequency and uses correspondingly smaller output transformers

In some embodiments, the lighting system 40, 40a includes a plurality of lamps without filaments (e.g., lamps having unconnected single electrodes) which are operated at a high frequency. The absence of filaments eliminates filament sputtering and/or burnout and the high frequency operation slower the voltage potential across the lamp such that a reactive element in the lamp is depleted evenly from end to end, increasing lamp life, for example, by as much as six times. The use of non-filament lights further enables low temperature operation of the one or more lamps, as there is no need to heat a filament.

In some embodiments, the lighting system 40, 40a may include one or more inert gas lamps, such as, for example, inert gas lamps containing argon, neon, krypton and/or mixtures thereof. The ballast of the lighting system 40, 40a provides for illumination at voltages as low as 100 to 200 volts, as compared to, for example, voltages of 2000 to 5000 volts for prior neon lamps. In some embodiments, lighting system 40, 40a include a plurality of lights (such as up to 8 lights) coupled to a single ballast. The single ballast reduces current needs and provide a more efficient starting voltage for each of the plurality of lights connected to the ballast, providing a reduction in resistance (such as, for example, a 700% reduction in resistance) and provides a corresponding decrease in energy consumption, wiring, and heat dissipation.

In some embodiments, the improved lighting systems 40, 40a discussed herein may provide, for example, improved lighting in indoor farming settings, schools, hospitals, street lights, sports arenas, and/or any other environment in which a reduced temperature lighting system and/or providing re-ballasting in seconds/minutes would be advantageous.

FIG. 18 illustrates a flow diagram of a ballast circuit 2500, in accordance with some embodiments. An input 2503 is configured to receive a voltage input signal, such as an A.C. voltage input signal. The input 3 may include a neutral lead and a hot lead and can be configured to receive any suitable A.C. input, such as, for example, 120 volts, 240 volts, etc. In some embodiments, the ballast circuit 2500 and/or the lighting system 40 includes a socket and/or wire for coupling the ballast circuit 2500 to an input power source.

In some embodiments, the ballast circuit 2500 includes a rectifier 2505 configured to receive an A.C. input signal from the input 2503 and generate one or more output D.C. voltages. For example, in some embodiments, the rectifier 2505 is configured to generate a plurality of low voltage D.C. signals 2511 to power additional electronic circuitry of the lighting system 40, 40a and/or the ballast circuit 2500. As another example, in some embodiments, the rectifier 2505 is configured to generate one or more high voltage D.C. signals, such as through the use of a doubler 2507 and/or additional circuitry to increase a voltage/power level of a generated D.C. signal.

In some embodiments, the doubler circuit 2507 supplies the high voltage D.C. signal and to a first MOSFET 2525 and a second MOSFET 2527. The MOSFETs 2525, 2527 are controlled by gate driver circuitry 2523 coupled to a PWM circuit 2515. The MOSFETs 2525, 2527 may be alternated between a high voltage and ground, at 180 electrical degrees apart such that a high frequency output is fed into the input of one or more isolation transformers 2529, 2531. The one or more isolation transformers 2529, 2531 receive a high frequency symmetrical, alternating signal relative to a neutral lead which, with filtering, approaches a sinusoidal wave.

In some embodiments, the outputs of the isolation transformers 2529 and 2531 are provided to a plurality of lamps 2533 and 2535 each having one or more unconnected single electrodes. In some embodiments, an additional output of the isolation transformers 2529, 2531 is provided to a comparator circuit 2513.

In some embodiments, the comparator circuit 2513 receives an externally generated control signal 2517 and compares the control signal 2517 to one or more feedback signals received from the transformers 2529 and 2531. The control signal 2517 may be configured to control operation of the lamps 2533, 2535, for example, controlling an on/off state of the lamps 2533, 2535, dimming of the lamps 2533, 2535, and/or otherwise controlling functions of the lamps 2533, 2535. In some embodiments, the comparator circuit 2513 is configured to generate at least one timing signal for the PWM circuit 2515. The at least one timing signal is configured to adjust the output provided by the PWM circuit 2515 to the MOSFET gate driver 23, which in turn controls operation of the MOSFETs 2525, 2527. By controlling the firing of the MOSFET's 2525 and 2527, the frequency of the output voltage waveform of the MOSFET's 2525 and 2527 may be adjusted. For example, in some embodiments, increasing the frequency output of the MOSFETs 2525, 2527 causes the lamps 2533, 2535 to dim.

In some embodiments, the ballast circuit 2500 includes a lamp sensing circuit 2519 configured to detect a fault in at least one lamp 2533, 2535 coupled to the ballast circuit 2500. A power signal from the rectifier 2505 and feedback signals from the lamps 2533, 2535 are input to the lamp sensing circuit 2519 which senses the current draw of the lamps 2533, 2535. The lamp sensing circuit 2519 provides an input to a fault detector circuit 2521, which is configured to detect a fault in the lighting system 40, 40a. For example, a fault occurs when one or more lamps 2533, 2535 are missing/burnt-out, causing a load change and changing the current draw of the lamps 2533, 2535. If such a fault is detected, the fault detector 2521 causes the MOSFET gate driver 2523 to change the signals to the MOSFET switching circuits 2525 and 2527 so that power to the lamps 2533, 2535 is decreased or completely shut off.

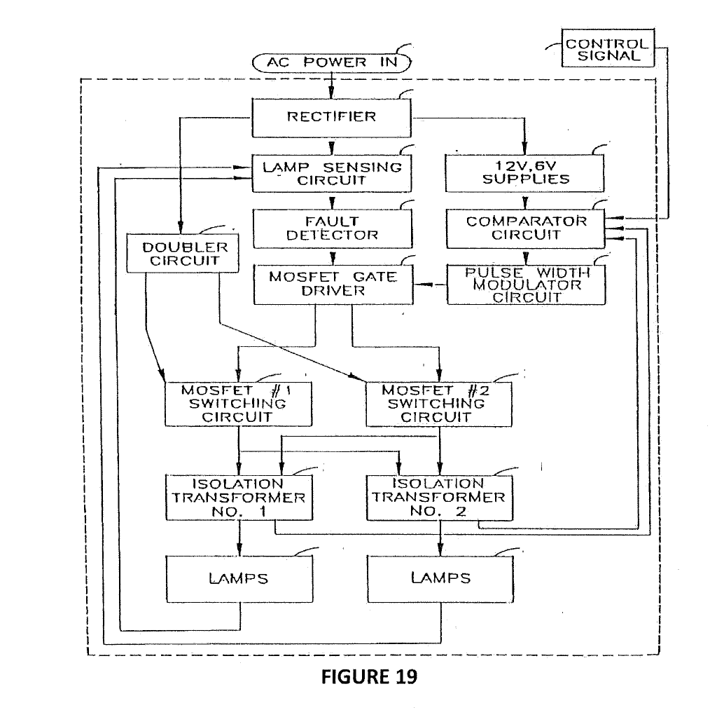

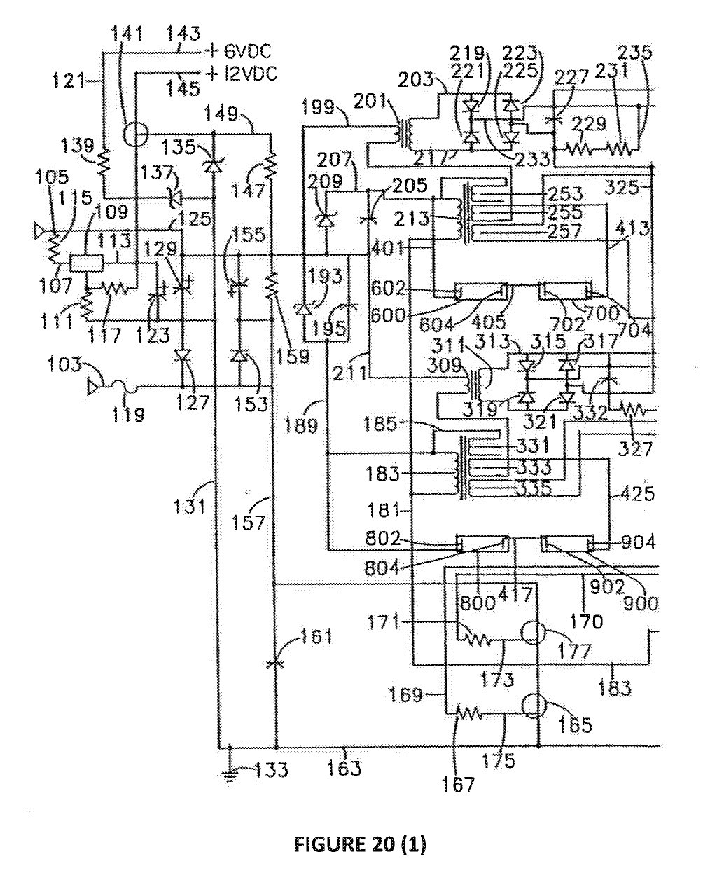

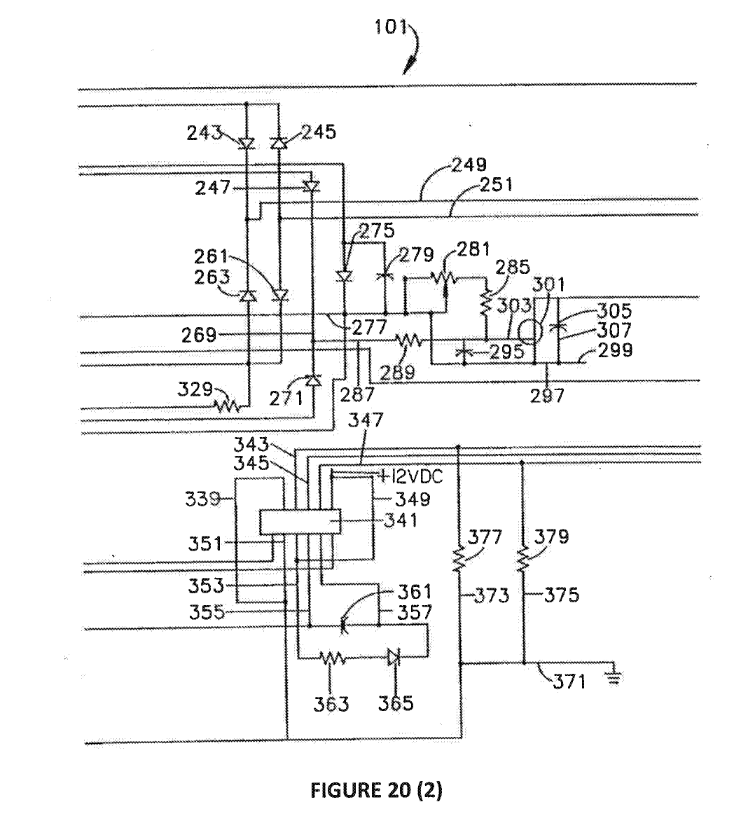

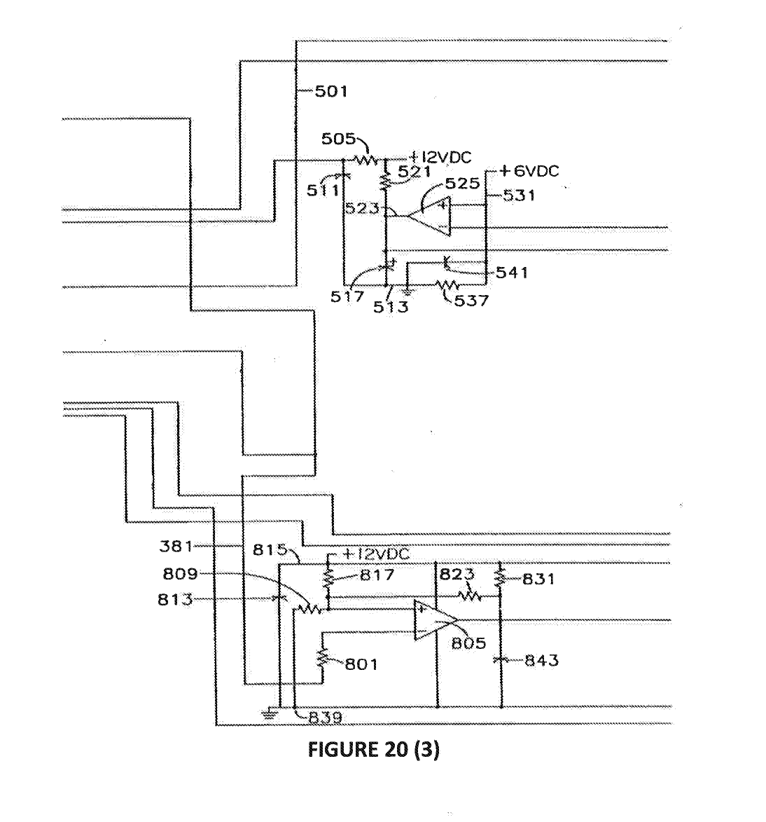

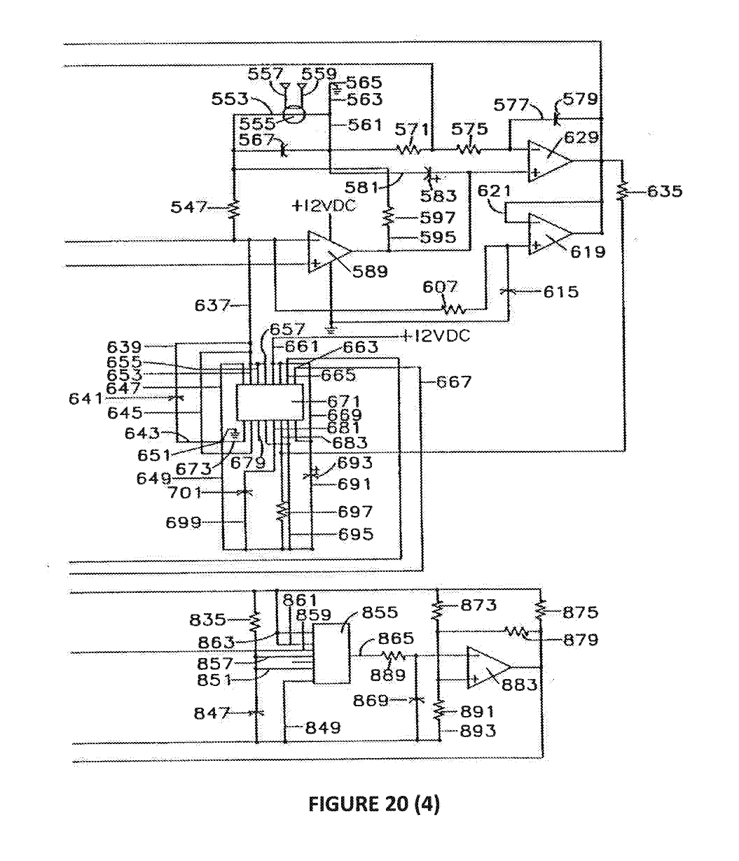

FIG. 19 illustrates a schematic circuit diagram of a ballast circuit 101, in accordance with some embodiments. Segments 103 and 105 show a 120V A.C. input. The A.C. input signal is used in three ways: to supply high voltage bias to a power switching network, to be used in a 12V power supply, and to be used as an offset voltage in a transformer network. In some embodiments, a fuse 119 serves as an over current protection device.

In some embodiments, the A.C. input voltage is rectified by 1000 μF power capacitors 129, 155, and diodes 127, 153. A byproduct of the rectification process is that the output voltage is doubled to approximately 75V across wire 131 to wire 157. When 103 is positive, 153 conducts and charges 155. When 103 is negative, 105 is positive and charges 129. When 103 returns positive, 129 discharges and make the negative reference of 155 approximately 180V D.C. Capacitor 155 charges and adds another 180V to the negative reference, resulting in approximately 360 to 375 volts at the junction of 153 and 155 relative to the junction of 127 and 129. This voltage serves as the working voltage for the switching network to be described later. The junction of diode 127 and capacitor 129 is connected by wire 131 to ground 133. Resistor 159 (16.2 kΩ) serves as a drain device to bleed off the high voltage stored in the power capacitors 129 and 155.

The rectified voltage is stepped down through, for example, 2.5 kΩ power resistor 115 and used to derive the 12V power supply voltage. Resistor 115, connects to voltage regulator 109 by wire 107, which regulates its output voltage to approximately 5V using reference resistors 117 (82Ω) and 111 (1.8 kΩ). The output voltage of 109 on wire 113 is filtered by 470 μF capacitor 123 to remove any ripple voltage. The regulator output, taken at the junction of the output pin of 109 and capacitor 123 (wire 113) is then used as bias voltage for the switching a field-effect transistor (FET) 141. The gate of FET 141 is connected to wire 149 which connects to 150 kΩ resistor 147 from the A.C. line 125. This drain voltage is regulated at 24V by a zener diodes 135, 137, and 5.1 kΩ resistor 139 which steps the 24V down to 6V on wire 143 for use in the comparator network to be described later. The source voltage is regulated at 12V on wire 145 for use as the voltage supply for the electronic components.

One side of an 85 turn primary winding 213 is oscillated in parallel with an 85 turn winding 183 of a second transformer by the switching signal at the junction of the source of MOSFET 177 and the drain of MOSFET 165. The other side of 213 is connected to the one turn secondary winding 253, the waveshaping network of 0.033 μF capacitor 205 and varistor 209 by wire 207, and also to electrode 602 of lamp 600 by wire 401. The switching signal generated by the MOSFET network is essentially a square wave, and this signal must be conditioned before it is connected the lamps. Capacitor 205 smoothes the signal and varistor 209 protects against any overvoltage spikes, resulting in a symmetrical wave approximating a sinusoidal waveform. On the other side of lamp 600, electrode 604 is connected to electrode 702 of lamp 700 by wire 405. Secondary winding 255 (one turn) has one side connected to electrode 704 of lamp 700 by wire 413 and the other side of 255 is connected to the A.C. bus 125 connected by wire 199 through the center of toroid 201. This gives winding 255 an offset voltage with which to excite the lamps, so that there is a voltage between the electrodes of each lamp, which is about equal to the voltage across primary winding 213.

Secondary winding 257 (one turn) acts as a current sensing device and is used as an input to one of the auxiliary lamp sensing circuits to be described later. One side of 257 passes through diode 247, while the other is connected to the ground 49 by wire 277.

The function of the second transformer mirrors the first, as they are operated in parallel. The primary winding 183 is excited by the same MOSFET switching signal as the first transformer from wire 181. Capacitor 195 (0.033 μF and Varistor 193 shape the square wave into a sinusoidal wave to wire 189 connected to winding 183.

The secondary winding 331 (one turn) on one side is connected to the primary by wire 185, while the other side is not connected. The primary is connected to the electrode 802. On the other side of 800, electrode 804 is connected to electrode 902 of lamp 900 by wire 417. Secondary winding 83 (one turn) has one side connected to electrode 904 of lamp 900 by wire 425. The other side of 83 is connected to the rectified A.C. bus 125 connected through a jumper wire through the center of toroid 59. This gives winding 83 an offset voltage with which to excite the lamps so that there is a voltage between the electrodes of each lamp, which is about equal to the voltage across primary winding 183.

Secondary 85 (one turn) acts as a current sensing device and is used as an input to one of the auxiliary lamp sensing circuits to be described later. One side of 85 passes through diode 271, while the other is connected to the ground 49 by wire 277. In the absence of a lamp load, or the presence of an excessive load, the MOSFET switching network operates in a severe overcurrent mode. This condition will persist in the initial steady state, as there are only open electrodes acting as a load, since the lamps are not yet ionized. Therefore, a fault detector circuit may be required.

A reference voltage is established at the high input of comparator 805 by the resistive network of 20 kΩ resistor 817 and 10 kΩ resistor 809. These resistors form the reference with a simple voltage divider using 12V supply 815, which has been filtered by 1 μF capacitor 813 connected between 12V 815 and ground 839. The sensing input from wire 381 passes through series 10 kΩ resistor 801 and terminates at the low input of 805. When this input is below the reference level at the high input (i.e., as during a fault condition), the output of 805 is high. When the input is above the reference value (normal operating conditions), the output of 805 is low. Resistor 823 (3.3 MΩ) is used to stabilize the output of 805 against oscillation and is connected between the output pin and high input of 805. Resistor 831 (10 kΩ) serves as a pull up resistor between the output pin of 805 and the 12V supply line. Any noise at this output is removed by the 1 μF capacitor to ground 843. Under normal operating conditions, the output of 805 will first be high, and then drop to low. This is because as the lamps are first started, they appear similar to a fault condition, and then after they are lit settle down and appear as a normal load. If the lamps fail to strike, as in a fault condition, the output of 805 will remain high.

The output of 805 is fed into the trigger input 859 of a timer chip 855. This timer chip is configured to act as a time delay one-shot circuit. The length of the delay is determined by the combination of 2.2 MΩ resistor 835 and 1 μF capacitor 847. The junction of 835 and 847 is connected to both timing pins of 855 by wires 857 and 851. The supply 863 and reset 861 pins of 855 are shortened together and tied directly to the 12V 815 supply line. The ground pin of 855 is tied to the ground bus by wire 849. When the output of 805 falls low, the falling edge triggers the timer of 855 to start operating. After the delay, determined by 835 and 847, the output of 855 goes high and remains high. If the output of 805 remains high, there is no falling edge, and the output of 855 remains low.

The output is buffered from the next comparator stage by the series 1 MΩ resistor 889, and any noise is removed by 1 μF capacitor 869. A reference voltage is established by equivalent 2.2 MΩ resistors 873 and 891 connected between 12V D.C. and ground, and their junction connected to the high input of 883. The low input to 883 is taken from the junction of 889 and 869. When the input 855 is low, the output of 833 remains high, only going low when the input rises above the level determined by 873 and 891. This output is stabilized by 3.3 MΩ resistor 879 connected between the output pin and the junction of 873 and 891 which connects to the high input of 883. The last component of this section is the 499 kΩ pull up resistor 875 connected between the output of 883 and the 12V supply line. The output of 883 is then connected to the shutdown pin of the MOSFET driver 91 by wire 95. When this signal is high, no oscillation occurs. When the shutdown signal is low, oscillation is allowed as normal.

The MOSFET gate driver circuit is used to ensure proper turn on at the gates of MOSFETs 177 and 165, i.e., no reverse currents and proper gate voltage. The 12V supply line provides power to the gate driver 91 by wire 99. The grounding for 91 is at wire 351 which is also connected to wire 89. Wire 351 connects to wire 163 which ties to ground 133. Wires 667 and 93 are the inputs to 91 for the oscillating square wave from the pulse width modulation. In effect, 97 and 93 are two of the three control signals. As long as wire 95 (the shutdown input) remains low, these inputs will allow gate driver 91 to control the switching outputs. When a voltage is applied to wire 95 from the fault detector circuit, the outputs of gate driver 91 are disabled until the voltage at wire 95 falls to zero.

The switching outputs of gate driver 91 are found at wires 169 and 170 with wire 169 being the low side voltage switch and wire 170 being the high side voltage switch. The high side voltage is established by taking the high voltage at the source of 177 and feeding it through a bootstrap circuit consisting of 20Ω resistor 363, diode 365, and 0.1 μF capacitor 361. The 12V at wire 353 causes diode 365 to conduct after passing through 363. This section acts as the charging scheme for capacitor 361. Capacitor 361 is connected between wire 355 and wire 357. Capacitor 361 stores the voltage at the source of 177 and uses it as the high side switching voltage. The junction between capacitor 361 and diode 365 is connected to gate driver 91 by wire 357.

MOSFETs 177, 165 are connected in a half bridge configuration and provide the high voltage switching to operate the transformers and drive the lamps. The high voltage supply at the drain of 177 is taken from the output of the doubler circuit at the junction of 153 and 155 by wire 157. Any ripple present at this point is removed by the 0.68 μF filter capacitor 161, which is connected between the high voltage supply and ground. The gate of 177 is turned on by the high voltage output of the gate driver circuit, with 20Ω resistor 171, connected by wire 173, acting as a buffer to reduce the gate voltage level slightly.

When the gate is turned on, the high voltage supply is switched through to the source of 177, which is connected to the drain of 165, the bootstrap circuit connected by wire 183, and the primary of transformer 213. This is the high power oscillating signal used to drive the lamps. The switching signals from 91 on wires 169 and 170 alternate 180 electrical degrees out of phase so that when 177 is on, 165 is off, so at the junction of the source of 177 and the drain of 165, the voltage is 75 V. When the gate of 177 is off, 165 turns on, making the potential at the junction equal to ground. The gate of 165 is turned on in the same fashion as 177, with 20Ω resistor 167, connected by wire 175, acting to soften the gate turn on voltage.

The pulse width modulator (PWM) circuit uses a PWM chip 671 to supply the timing signals to the MOSFET gate driver circuit, and ultimately control the frequency of MOSFET oscillation. These timing signals may be generated by other means but in this embodiment this PWM circuit supplies the alternating, high frequency timing signals.

Power for PWM 671 comes from the 12V supply line connected by wire 661. Capacitor 693 (10 μF) acts as a local filter from the 12V line to ground by wire 691. The 12V supply is also connected by wires 669 and 663 to the collectors of the chip's output transistors, and this voltage simply serves as the bias voltage for them. Grounding 651 for PWM 671 is supplied by 695, which is also connected to the dead time control pin by 679, non-inverting input #1 by 673, and non-inverting input #2 by 647. The regulated reference output is connected by 655 to 657, 653, and 645 A 0.1 μF capacitor 641 is connected from 653 by 639 to ground 651 by wire 643 to smooth the D.C. voltage. This D.C. voltage serves as the inverting input for the error amplifiers of PWM 671, as well as the output control voltage. The timing for 671 is determined by the combination of 22.6 kΩ resistor 697 and 1000 pF capacitor 701 connected to ground by wire 699. Resistor 697 is connected to PWM 671 by 683 and 649 to ground, while capacitor 701 is connected from wire 681 to ground. At the junction of 697 and wire 683 is attached one side of 16.2 kΩ series resistor 635, which affects the frequency of oscillation based on the dimming signal to be described later.

The outputs of PWM 671 are taken from the emitters of the output transistors, at wires 665 and 667. These outputs are then connected to inputs of gate driver 91. Resistors 377 and 379 (10 kΩ each) are shunted across each output line respectively by wires 373 and 375, to ground 371 to stabilize the outputs locally. The output of the toroid 203, 217, represent the current passing through the secondary winding 255. This is an A.C. voltage and must be rectified to D.C. Diodes 219, 221, 223 and 225 are configured in a full wave bridge rectifier formation. The full wave rectified signal is then filtered through 0.1 μF capacitor 227 to remove the ripple voltage. Capacitor 227 is connected on one side to the junction of 219 and 221, and on the other side to the junction of 223 and 225. The input to the shutdown circuit is also taken from this point, and is connected to resistor 801 by wire 381. Resistors 229 and 231 (182Ω each) serve as a bleeder for capacitor 227 connected by wire 235. These resistors are equivalent and can be replaced by one resistor equal to the sum of two. It is not critical to this embodiment that the two resistors be in series. Diode 275 and 0.1 μF capacitor 279 couple the junction of 227 and 229 to ground.

The operation of the second lamp sensing circuit mirrors the first, much as the transformer operation is the same. The output of the toroids, across 61, represents the current passing through the secondary winding 83. This is an A.C. voltage and must be rectified to D.C. Diodes 65, 69, 71 and 67 are configured in a full wave bridge rectifier formation. The full wave rectified signal is then filtered through 0.1 μF capacitor 82 to remove the ripple voltage. Capacitor 82 is connected on one side to the junction of 65, 69, and on the other side to the junction of 67, 71. This junction is connected to the junction of diodes 223, 225 by wire 75. The input to the shutdown circuit is taken from the junction of 65, 67 and is connected to resistor 801 by wire 381. Resistors 77 and 79 (182Ω each) serve as a bleeder for capacitor 72. These resistors are equivalent and can be replaced by one resistor equal to the sum of two. It is not critical to this embodiment that the two resistors be in series.

Diodes 243, 245, 262, and 263 may be used to sum together the outputs of the dual toroidal full wave bridge circuits. Essentially, they may act as another full wave bridge stage. The junction of 261 and 243 is connected by wire 249 to the junction of resistors 571 and 575 in the comparator network, to be described later. The junction of 245 and 263 is connected by wire 251 to the junction of resistor 505 and capacitor 511 in the comparator network.

Diode 247 passes only the positive portion of the lamp sensing signal from winding 257. This positive portion is then summed with the positive portion of winding 85, which has also passed through diode 271. The junction of 271 and 247, wire 269, which is always a positive voltage, is applied to the gate of FET 51, first passing through 16.2 kΩ resistor 39, resistor 39 being connected to the diode junction by wire 37 and to the gate by wire 53. The voltage at the gate is divided by the resistive network of 39, 3.8 kΩ 35 and 5 k potentiometer 6. This network is used to set the turn on voltage for the gate of the FET 51 by adjusting the value of 6. Capacitor 45 (22 μF) filters out any noise between wire 53 and ground on wire 47, which may have infiltrated the signal coming from the windings 257, 85. Capacitor 55 (0.1 μF) couples the drain voltage of FET 51 by wire 57, to the voltage coming from pin 1 of comparator 629 through wire 501. The source of FET 51 is connected to ground 49 by wire 47.

The 6V supply 531 derived in the power supply section here acts as a reference voltage at the high input of comparator 525. The 6V supply 531 is filtered by 0.1 μF capacitor 541 from 531 to ground 513 and stabilized locally by 9.91 kΩ resistor 537 shunted from 531 to the ground 513. The low input gets its level from the regulated 5V output from wire 637 in the PWM circuit. Since this comparator is in the inverting mode, the output to wire 523 will be high. The output rises slowly, as it charges 22 μF capacitor 517 connected between the output and ground 513. The speed at which the output rises is controlled by the pull up resistor 521 (45 k). The smaller the value of 521, the faster 517 will charge. Resistor 521 is connected on one side to the output of 525 and on the other side to the junction of the 12V supply line, and to 10.7 kΩ resistor 505. Resistor 505 here works as a pull up resistor for the junction of diodes 245 and 263, whose potential is nearly ground. Capacitor 511 (0.1 μF) is connected between wire 251 and ground 513.

The output of 525 is also connected to the high input of comparator 589. The low input of 589 is taken from the regulated 5V output of 621. The high input of 589 ramps up until it is at a higher potential than the low input. At this point, the output rises slowly, since it is charging 1 μF capacitor 583, whose positive side is connected to the output of 589 and high input of comparator 629. The negative side of capacitor 583 is connected to the ground. The output of 589 is also attached to 100 kΩ resistor 597, which connects to 10 kΩ. resistor 547, 1 pF capacitor 567, and the opto isolator chip 555. These resistors are used in the dimming mode which will be discussed later.

Comparator 629 gets a high input from the output of 589. The low input comes from the junction of diodes 243 and 261, which comes into the junction of the resistors 575 (32.7 kΩ) and 571 (100 kΩ). Resistor 571 goes between the junction of diodes 243 and 261 and the ground for stability, while resistor 575 goes from this junction to the low input of 629. Also meeting at the low input of 629 is one side of 0.47 μF capacitor 579, connected by wire 577, which is connected as a feedback capacitor from the output of 629. This input is taken from the lamp sensing circuit. When the lamps are not yet lit, the signal is low, but once the lamps light, the voltage here goes high. The low input goes high faster than the high input, which is more of a slow ramp. When the voltage at the high input finally exceeds the voltage at the low input, the output of 629 goes high.

The output of 629 is connected to the output of 619, the low input of 619 by wire 621, the feedback capacitor 579, and the series resistor 635. The high input of 619 comes from the low input of 589 through the 100 kΩ buffer resistor 607. To take out noise at this pin, 0.1 μF capacitor 615 is shunted from the high input to ground. The low input of 619 is connected to the output of 629. Comparator 619 is used to reduce the voltage present over resistor 635 at startup. When the input at the low input finally goes high as a result of comparator 629, the output of 619 then goes high also.

The control signal is supplied by an external device which outputs information to input pins of the optical isolator 555 between wires 557 and 559. This control signal may stem from the control systems discussed herein, and may accordingly provide the disclosed adaptive lighting, such as by controlling the ballast of the light system. The control information can be used to dim the ballast, or remotely turn the device on or off. When no control signal is present, the voltage at the collector of 555 is 5V at wire 553, since it is connected to the regulated output voltage of 671 though resistor 547. The emitter of 555 is connected to the ground 565 by wire 561.

Capacitor 567, connected from the collector of 555 to the ground 563, serves as a noise filter. The control signal, in this case a dimmer signal, causes a PWM signal to appear at the collector of 555, and the pulse width of this signal varies with dimmer input. As the duty cycle decreases, and the dead time increases at the collector of 555, the lower average voltage at this point causes the voltage at the output of comparator 589 to lower, allowing 583 to drain off. As 583 drains off, the voltage at the high input of 629 decreases, which causes the voltage at the output of 629 to drop off. Resistor 635 is the timing interface device between the comparator section and the PWM section. When voltage is applied over 635, it changes the effective resistance seen at the resistive timing of 671. As this effective resistance changes, the frequency of oscillation increases and the lamps dim.

For a remote on-off controller, the input to 555 is a D.C. voltage, and this causes the collector of 555 to fall to zero volts. At this point, the same characteristics are displayed as when dimming, except instead of dimming, the ballast shuts off.

The lamps used in the present system may be gas-filled and may have two unconnected, single electrodes. These are wired so that the high frequency voltage generated by the electronic circuiting is applied between the electrodes (i.e. between the electrodes 602 and 604 in lamp 600). In the above examples, the lamps are conventional fluorescent gas discharge lamps, i.e. commercially available lamps, with a mixture of inert gases argon, krypton, e.g. Other examples were performed with, for example, low voltage neon lamps.

In some embodiments, the control units discussed herein, such as control units 460, 504 discussed above, may be configured to control one or more of the ballast systems discussed above. Accordingly, these control units may receive unique algorithms particular to that which is controlled by a given control unit. Thus, for example, a particular control unit dedicated to growing strawberries may be provided with one or more software routines suitable for and/or optimized for growing strawberries, including, but not limited to, various algorithms for adaptive lighting, temperature, nutrient bath delivery, etc., dedicated to the successful growth of strawberries.

In some embodiments, the disclosed adaptive lighting and adaptive lighting arrays (inclusive of, for example, the movable light rigs and ballasts discussed throughout) provide significant improvement over the “fixed point” lights commonly used in known greenhouses and indoor and vertical farming. This is because so-called fixed point lights suffer from a variety of issues, particularly in an indoor farming context. For example, fixed point light bombards quanta onto a plant relentlessly, which is very unlike natural lighting, i.e., the sun, which is not fixed. The disclosed adaptive (and moving) lighting systems 40, 40a allow the plants to take in an optimal amount of quanta while managing the heat at an allowable throughput.

In some embodiments, the lateral movement of the disclosed adaptive lighting allows the quanta to penetrate deeper into the canopy by hitting a canopy from multiple angles as the lighting moves (similar to movement of the sun across the sky). Movement of the lighting source increases the standing density of the crop dramatically, since more plants can be fed the light in less space. In some embodiments, the adaptive light canopy delivers more light to the lower canopy and plants that might be blocked from single point light while also mitigating the heat. For example, in the case of vertical farming, fixed point lights act as heat sinks, thus heating the trays above. This, in turn, reduces the oxygen potential of the bath or mediums above the lights. Adaptive and moveable lighting systems, such as those disclosed herein, avoid this issue and allow nutrient baths in multiple levels to be maintained at optimal temperatures.

In contrast to the moveable lighting systems 40, 40a disclosed herein, fixed point lighting lacks vertical movement such that light sources are placed at fixed a height to transmit sufficient light to a seedling. The lighting must then nourish the plant until the desired growth height is reached. At the outset, the plant must stretch to reach the light, and at the close, the plant must be harvested before the height limitation determined by the fixed lighting crushes or burns the crop. Thus, fixed point lighting provides for the growth of small plants, such as baby lettuces and microgreens, but is problematic for growing larger plants, like full head lettuces, basil, cannabis, and larger flowering plants, as well as flowing plants, such as strawberries and tomatoes.

In some embodiments, the disclosed lighting systems 40, 40a maintain optimum light PAR for the plant canopy at all time and allows for the growth of plants to any desired height. For example, vertical movement of a light (e.g., raising the light to the optimum dispersion point against the canopy surface area, and then raising light as the plant grows) provide for optimal growth of larger plants. Vertically moveable lighting systems 40, 40a allow the use of lower wattage lighting (due to reduced distance between light transmission point and the plant. For example, the disclosed lighting systems 40, 40a may use, in some embodiments, 65 watts, or approximately 150 watts with the disclosed ballast system), allow for the adjustment of the light upwards as the plant canopy rises, and allow for the dimming of the light, thereby reducing the DLI (daily light integral).

In some embodiments, one or more sensors may be provided at the canopy to auto dim the light of the lighting systems 40, 40a if the output is out of balance with the canopy and provides an alert that the light needs to be raised. This alerting and/or raising and lowering of the light may occur manually and/or automatically. Thus, the plant growth stays synchronized to the lighting at all times.

The foregoing allows for more frequent maintenance, and hence cleaning, than in any prior art embodiments. Further, it allows for a relatively steady nature of a required maintenance algorithm in the use of the embodiments, i.e., the maintenance cycle is consistent over a longer periods of time than is the case in the known art. As mentioned, farming may thereby be performed even in urban areas, or within businesses, such as restaurants. Accordingly, artisan farmers may engage in their own farming and/or may license the right to employ the apparatuses, systems and methods discussed herein. Similarly, businesses may engage in farming on site, and may hire third parties to come in and service the farm on an as-needed basis, or at pre-determined intervals, in a manner akin to office coffee service replenishment systems that are known in the art.

Moreover, it can be seen that various features may be grouped together in a single embodiment during the course of discussion for the purpose of streamlining the disclosure. This method of disclosure is not to be interpreted as reflecting an intention that any claimed embodiments require more features than are expressly recited in each claim that may be associated herewith.

What is claimed is:

1. An indoor farming system, comprising:
a water-based nutrient bath resident in a tank;
a pump for pumping the bath from the tank upwardly through a plurality of pipes to at least one divided high-density table comprising growing crops resting in at least one float;
at least one non-block drain on each divided one of the tables, wherein the bath turbulently flows respectively across each of the divided tables and down the at least one non-block drain based on at least gravity, and then back into the tank that includes the nutrient bath; and
at least one solenoid having chilled liquid passing therethrough to maintain a temperature of the nutrient bath, wherein the at least one solenoid traverses substantially a lateral length of the tank.

2. An indoor farming system, comprising:
a water-based nutrient bath resident in a tank;
a pump for pumping the bath from the tank upwardly through a plurality of pipes to at least one divided high-density table comprising growing crops resting in at least one float;
at least one non-block drain on each divided one of the tables, wherein the bath turbulently flows respectively across each of the divided tables and down the at least one non-block drain based on at least gravity, and then back into the tank that includes the nutrient bath; and
adaptive mobile lighting having a high frequency ballast associated therewith, wherein the adaptive mobile lighting approximates natural light and operates with energy efficiency at partially due to the high frequency ballast.
